(19) United States
(12) Patent Application Publication
(10) Pub. No.: US 2005/0196196 A1
(43) Pub. Date: Sep. 8, 2005

(54) Electrophotographic apparatus

(75) Inventors: Mitsuhiro Ota, Toride-shi (JP); Michiyo Sekiya, Mishima-shi (JP); Hiroki Uematsu, Abiko-shi (JP); Shuji Ishii, Kashiwa-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/047,709

(22) Filed: Feb. 2, 2005

(30) Foreign Application Priority Data
Feb. 3, 2004 (JP) 2004-027072(PAT.)
Jan. 21, 2005 (JP) 2005-013967(PAT.)

(51) Int. Cl. G03G 15/00; G03G 15/01

(52) U.S. Cl. 399/159; 399/302; 430/60; 430/132; 430/133; 430/66

(57) ABSTRACT

The present invention relates to an electrophotographic apparatus of an intermediate transfer system, in which: the surface of an electrophotographic photoreceptor has a universal hardness value (HU) of 150 N/mm² or more to 220 N/mm² or less, and an elastic deformation rate of 48% or more to 65% or less; the surface of an intermediate transfer body has a universal hardness value (HU) of 220 N/mm² or less, and an elastic deformation rate of 50% or more; and the universal hardness value (HU) of the surface of the electrophotographic photoreceptor is greater than the universal hardness value (HU) of the surface of the intermediate transfer body.

### BACKGROUND OF THE INVENTION

1. Field of the Invention

The present invention relates to an electrophotographic apparatus. In particular, the present invention relates to an electrophotographic apparatus employing an intermediate transfer system.

2. Description of the Related Art

Image forming apparatuses have conventionally employed various systems such as an electrophotographic system, a heat transfer system, and an inkjet system. Of those, an image forming apparatus employing the electrophotographic system (electrophotographic apparatus) has superiority in speed, image quality, and silence over the image forming apparatuses employing the other systems.

Image formation according to the electrophotographic system generally involves: charging the surface of an electrophotographic photoreceptor; irradiating the charged surface of the electrophotographic photoreceptor with exposure light to form an electrostatic latent image on the surface of the electrophotographic photoreceptor; developing the electrostatic latent image with toner to form a toner image on the surface of the electrophotographic photoreceptor; transferring the toner image from the surface of the electrophotographic photoreceptor onto a transfer material such as paper; and cleaning the surface of the electrophotographic photoreceptor by removing the transfer residual toner. The surface of the electrophotographic photoreceptor is often charged by using a charging member (such as a charging roller) arranged to be in contact with the surface of the electrophotographic photoreceptor. In addition, the cleaning of the surface of the electrophotographic photoreceptor is often performed by using a cleaning member (such as a cleaning blade) arranged to be in contact with the surface of the electrophotographic photoreceptor.

An electrophotographic photoreceptor to be mounted on an electrophotographic apparatus must provide sensitivity, electrical characteristics, and optical characteristics depending on the electrophotographic process to be applied to the electrophotographic photoreceptor. In addition, electrical external forces and/or mechanical external forces such as charging, exposure (image exposure), development with toner, transfer onto paper or an intermediate transfer body, and cleaning of residual toner are directly applied to the surface of the electrophotographic photoreceptor. Therefore, the electrophotographic photoreceptor must be resistant to those external forces. Specifically, the electrophotographic photoreceptor must have resistance to: the development of a flaw or wear on its surface due to rubbing; surface deterioration due to charging (such as a reduction in transfer efficiency or sliding property); and the deterioration of electrical characteristics such as a reduction in sensitivity and a reduction in electric potential.

Moreover, not only monochrome electrophotographic apparatuses but also multicolor electrophotographic apparatuses (color electrophotographic apparatuses) have become widespread in recent years.

The color electrophotographic apparatuses employ various systems. Of those, an intermediate transfer system, which involves: sequentially overlapping toner images of respective colors each other on an intermediate transfer body to form a synthetic toner image (color toner image); and collectively transferring the synthetic toner image onto a transfer material such as paper, is superior to the systems each involving sequentially overlapping toner images of respective colors each other directly on a transfer material in that image quality and reliability are high when special transfer paper such as a cardboard, an envelope, or label paper is used as the transfer material.

As in the case of the electrophotographic photoreceptor, an intermediate transfer body to be mounted on an electrophotographic apparatus of an intermediate transfer system must have resistance to: the development of a flaw or wear on its surface due to rubbing; and surface deterioration (such as a reduction in transfer efficiency); and the deterioration of electrical characteristics such as a fluctuation in resistance.

An electrophotographic photoreceptor using an organic material for a photoconductive substance (such as a charge generating substance or a charge transporting substance), a so-called organic electrophotographic photoreceptor has been in common use as the electrophotographic photoreceptor because of its advantages including low cost and high productivity. Examples of the organic electrophotographic photoreceptor which is in mainstream include a photosensitive layer, which is so-called a laminated type photosensitive layer, obtained by laminating: a charge generating layer containing a charge generating substance such as a photoconductive dye or a photoconductive pigment; and a charge transporting layer containing a charge transporting substance such as a photoconductive polymer or a photoconductive low-molecular-weight compound.

In addition, a layer obtained by dispersing the molecules of a photoconductive substance into a binder resin is generally used as a surface layer (a layer placed on the outermost surface of an electrophotographic photoreceptor) of the organic electrophotographic photoreceptor. The mechanical strength of the surface of such an electrophotographic photoreceptor (resistance to electrical external forces and/or mechanical external forces) depends on the mechanical strength of the binder resin of the surface layer.

It is hard to say that the mechanical strength of the surface of a conventional electrophotographic photoreceptor suffices to meet the recent demands for improved image quality and extended service life. This is because of the following reasons. When the surface layer of the electrophotographic photoreceptor is formed according to a composition intended to achieve improved sensitivity for achieving improved image quality, a flaw or wear develops on the surface of the electrophotographic photoreceptor owing to rubbing with an abutting member such as a charging member or a cleaning member (a member arranged to be in contact with the surface of the electrophotographic photoreceptor) when the electrophotographic photoreceptor is repeatedly used. On the other hand, when the surface layer of the electrophotographic photoreceptor is formed according to a composition intended to provide flaw resistance or wear resistance for achieving extended service life, sensitivity reduces or a rest potential increases, with the result that electrophotographic characteristics cannot be satisfied. In addition, when a flaw or wear develops on the surface of the electrophotographic photoreceptor, the roughness of the surface increases and the capacity of the electrophotographic photoreceptor varies in a minute range, thereby leading to a reduction in uniformity of sensitivity.

To solve those problems, for example, JP02-127652 A discloses a technique involving the use of a specific curing resin as a binder resin of a charge transporting layer serving as a surface layer. In addition, for example, JP 05-216249 A and JP 07-072640 A each disclose a technique in which a cured film obtained by curing a monomer having a carbon-carbon double bond with energy such as heat or light is used as a surface layer of an electrophotographic photoreceptor.

However, each of the electrophotographic photoreceptors disclosed in them is susceptible to improvement from the viewpoint of compatibility between the sensitivity and the mechanical strength of the surface.

By the way, a “hardness” is one of the measures of the degree of deterioration of the mechanical strength of the surface of an electrophotographic photoreceptor, and attempts have been made to quantify the hardness. Examples of the quantification method include a scraping hardness test, a pencil hardness test, and a Vickers hardness test.

However, even in electrophotographic photoreceptors showing high surface hardnesses according to those tests, in some cases, a flaw or wear develops more easily than in electrophotographic photoreceptors showing low surface hardnesses, or a flaw develops although wear hardly develops. In other words, it cannot be said that a correlation always exists between a surface hardness deduced from the scraping hardness test, the pencil hardness test, the Vickers hardness test, or the like and the mechanical strength of the surface of the electrophotographic photoreceptor.

Although depending on measurement methods, most of the hardnesses are quantified from deformation amounts of a measuring object. However, deformations can be classified into a plastic deformation and an elastic deformation. It is probably impossible to deduce a hardness only from the total deformation amount without taking the classification into consideration.

Recent development of a technique of a hardness meter has made a hardness measuring device sophisticated. As a result, it has become possible to measure physical properties including a plastic deformation amount and an elastic deformation amount with high accuracy.

To improve the mechanical strength of the surface of an electrophotographic photoreceptor, not only its hardness but also its elastic deformation rate must be increased.

By the way, the shape of a flaw that suddenly develops when foreign matter is sandwiched between an electrophotographic photoreceptor with a surface having a high hardness and a high elastic deformation rate and an abutting member is characteristic as compared to a flaw that develops in an electrophotographic photoreceptor without such a surface.

FIG. 8(a) shows an example of a flaw developing in the electrophotographic photoreceptor with a surface having a high hardness and a high elastic deformation rate, while FIG. 8(b) shows an example of a flaw developing in the electrophotographic photoreceptor without such a surface.

As shown in FIG. 8(a), the flaw that develops when foreign matter is sandwiched between the electrophotographic photoreceptor with a surface having a high hardness and a high elastic deformation rate and the abutting member has a shape in which a width narrows and sharpens and both end portions of the flaw bump.

In an electrophotographic apparatus of an intermediate transfer system, an intermediate transfer body with good follow ability to the surface of an electro photographic photoreceptor must be used in order to continuously form good images even when a flaw having a shape shown in FIG. 8(a) develops on the surface of the electrophotographic photoreceptor.

However, a material having a low hardness has been conventionally used for the intermediate transfer body with good followability to the surface of the electrophotographic photoreceptor. Therefore, the intermediate transfer body is worn out owing to rubbing with the flaw on the surface of the electrophotographic photoreceptor, so it has been difficult to form good images continuously.

For example, JP2003-316175 A discloses an electrophotographic apparatus in which: an electrophotographic photoreceptor has a universal hardness of 150 to 350 N/mm²; an intermediate transfer body (intermediate transfer belt) has a universal hardness of 10 to 200 N/mm²; and the universal hardness of the electrophotographic photoreceptor is greater than the universal hardness of the intermediate transfer body.

However, the mechanical strength of the surface of the intermediate transfer body of the electrophotographic apparatus disclosed in JP 2003-316175 A does not suffice for combined use with an electrophotographic photoreceptor, which has a high mechanical strength with a surface having a high hardness and a high elastic deformation rate. When a flaw having a shape shown in FIG. 8(a) develops on the surface of the electrophotographic photoreceptor, there arises a problem in that a flaw or wear develops on the surface of the intermediate transfer body owing to the flaw.

### SUMMARY OF THE INVENTION

An object of the present invention is to provide an electrophotographic apparatus of an intermediate transfer system on which an electrophotographic photoreceptor that has a high mechanical strength with a surface having a high hardness and a high elastic deformation rate is mounted, in which, even when the above characteristic flaw (flaw having a shape shown in FIG. 8(a)) suddenly develops on the surface of the electrophotographic photoreceptor, the above detrimental effects due to the flaw are suppressed, so good images can be formed continuously.

That is, according to the present invention, there is provided an electrophotographic apparatus, including:
an electrophotographic photoreceptor having a support and a photosensitive layer arranged on the support;
charging means, which has a charging member arranged to be in contact with a surface of the electrophotographic photoreceptor, for charging the surface of the electrophotographic photoreceptor by using the charging member;
exposing means for forming an electrostatic latent image on the surface of the electrophotographic photoreceptor charged by the charging means by irradiating the surface of the electrophotographic photoreceptor with exposure light;
developing means for developing the electrostatic latent image on the surface of the electrophotographic photoreceptor formed by the exposing means with toner to form a toner image on the surface of the electrophotographic photoreceptor;
an intermediate transfer body;
a primary transfer member for primarily transferring the toner image on the surface of the electrophotographic photoreceptor formed by the developing means onto a surface of the intermediate transfer body;
a secondary transfer member for secondarily transferring the toner image on the surface of the intermediate transfer body primarily transferred by the primary transfer member onto a transfer material; and
cleaning means, that has a cleaning member arranged to be in contact with the surface of the electrophotographic photoreceptor, for cleaning the surface of the electrophotographic photoreceptor by removing the toner remaining on the surface of the electrophotographic photoreceptor after the primary transfer by the primary transfer member by using the cleaning member, in which:
the surface of the electrophotographic photoreceptor has a universal hardness value (HU) of 150 N/mm² or more to 220 N/mm² or less, and an elastic deformation rate of 48% or more to 65% or less;
the surface of the intermediate transfer body has a universal hardness value (HU) of 220 N/mm² or less, and an elastic deformation rate of 50% or more; and
the universal hardness value (HU) of the surface of the electrophotographic photoreceptor is greater than the universal hardness value (HU) of the surface of the intermediate transfer body.

### BRIEF DESCRIPTION OF THE DRAWINGS

In the accompanying drawings:

FIG. 1 is a conceptual drawing showing a relationship between a universal hardness value (HU) and an elastic deformation rate on the surface of an electrophotographic photoreceptor;

FIG. 2 is a drawing showing an outline of an output chart of a Fischer scope H100V;

FIG. 3 is a drawing showing an example of the output chart of the Fischer scope H100V;

FIGS. 4(a) to 4(i) are drawings each showing an example of a layer structure of the electrophotographic photoreceptor;

FIG. 5 is a schematic sectional drawing showing an example of an electrophotographic apparatus;

FIGS. 6(a) and 6(b) each show measurement data according to a two-dimensional contact surface roughness tester;

FIG. 7 shows measurement data according to the two-dimensional contact surface roughness tester; and

FIGS. 8(a) and 8(b) are drawings each showing an example of a flaw developing in the electrophotographic photoreceptor.

### DETAILED DESCRIPTION OF THE PREFERRED EMBODIMENTS

Hereinafter, the present invention will be described in detail.

As described above, the surface of the electrophotographic photoreceptor to be used in the present invention has a universal hardness value (HU) of 150 N/mm² or more to 220 N/mm² or less, and an elastic deformation rate of 48% or more to 65% or less under a 25° C./50% RH environment.

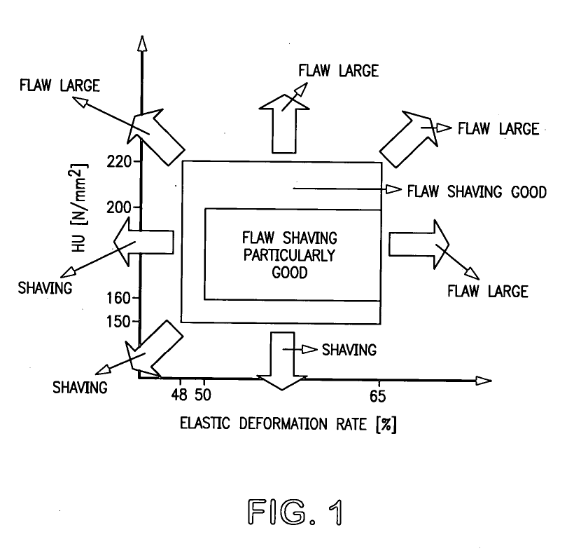

FIG. 1 shows a relationship between the universal hardness value (HU) and the elastic deformation rate on the surface of the electrophotographic photoreceptor to be used in the present invention (conceptual drawing).

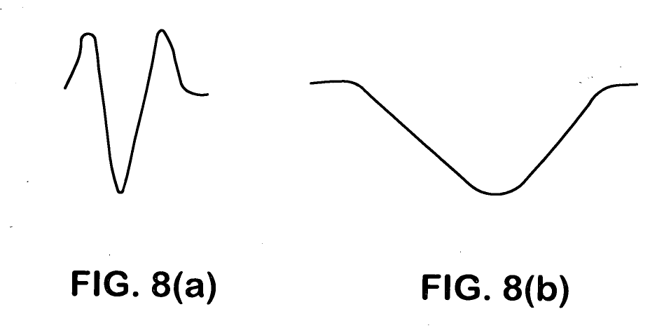

For example, when the universal hardness value (HU) of the surface of the electrophotographic photoreceptor is excessively large, or the elastic deformation rate of the surface is excessively small, the surface of the electrophotographic photoreceptor provides an insufficient elastic force. In this case, the surface of the electrophotographic photoreceptor is rubbed with paper powder or toner sandwiched between the electrophotographic photoreceptor and an abutting member such as a charging member or a cleaning member. Thus, a flaw (flaw illustrated in FIG. 8(b)) easily develops on the surface of the electrophotographic photoreceptor, with the result that wear also easily develops. In addition, when the universal hardness value (HU) is excessively large, an elastic deformation amount is small even though the elastic deformation rate is large. As a result, a large pressure is exerted on a local area in the surface of the electrophotographic photoreceptor, so a deep flaw (flaw illustrated in FIG. 8(b)) easily develops on the surface of the electrostatic photoreceptor. In other words, it cannot be said that an electrophotographic photoreceptor having a large surface hardness (which is not limited to a universal hardness value (HU), and includes a hardness deduced from the scraping hardness test, the pencil hardness test, the Vickers hardness test, or the like) is always preferable.

In addition, when the elastic deformation rate is excessively large, a plastic deformation amount is also large even though the universal hardness value (HU) falls within the above range. In this case, the surface of the electrophotographic photoreceptor is rubbed with paper powder or toner sandwiched between the electrophotographic photoreceptor and the abutting member such as a charging member or a cleaning member. Thus, a fine flaw (flaw illustrated in FIG. 8(b)) easily develops on the surface of the electrophotographic photoreceptor, with the result that wear easily develops.

In addition, when the elastic deformation rate is excessively small, the plastic deformation amount is relatively large even though the universal hardness value (HU) falls within the above range. Thus, a fine flaw (flaw illustrated in FIG. 8(b)) easily develops on the surface of the electrophotographic photoreceptor, with the result that wear easily develops. This phenomenon is particularly remarkable when not only the elastic deformation rate but also the universal hardness value (HU) is excessively small.

The electrophotographic photoreceptor of the present invention with a surface having a universal hardness value (HU) of 150 N/mm² or more to 220 N/mm² or less, and an elastic deformation rate of 48% or more to 65% or less is excellent in resistance to the development of a flaw (flaw illustrated in FIG. 8(b)) or wear on the surface. However, the above-described characteristic flaw shown in FIG. 8(b) tends to suddenly develop on the surface. In addition, the surface is hardly shaved, so the characteristic flaw is apt to be kept for a long period of time.

In the electrophotographic apparatus of an intermediate transfer system, an intermediate transfer body with good followability to the surface of the electrophotographic photoreceptor must be used in order to continuously form good images even when the characteristic flaw develops on the surface of the electrophotographic photoreceptor.

However, a material having a low hardness has been conventionally used for the intermediate transfer body with good followability to the surface of the electrophotographic photoreceptor. As a result, the intermediate transfer body is worn out owing to rubbing with the characteristic flaw on the surface of the electrophotographic photoreceptor, so it has been difficult to form good images continuously.

In view of the above, the inventors of the present invention have made extensive studies to find that an intermediate transfer body with a surface having a universal hardness value (HU), which is smaller than the universal hardness value (HU) of the surface of the electrophotographic photoreceptor, of 220 N/mm² or less, and an elastic deformation rate of 50% or more can satisfactorily follow the electrophotographic photoreceptor, making it difficult for wear resulting from the characteristic flaw on the surface of the electrophotographic photoreceptor to develop.

To express such an effect more sufficiently, the universal hardness value (HU) of the surface of the electrophotographic photoreceptor is more preferably 160 N/mm² or more to 200 N/mm² or less, and the elastic deformation rate of the surface is more preferably 50% or more to 65% or less. In addition, the universal hardness value (HU) of the surface of the intermediate transfer body is more preferably 100 N/mm² or less, still more preferably 70 N/mm² or less, on the other hand, it is more preferably 5 N/mm² or more, still more preferably 10 N/mm² or more. In addition, the elastic deformation rate of the surface of the intermediate transfer body is preferably 50% or more to 80% or less.

In the present invention, the universal hardness value (HU) and elastic deformation rate of the surface of the electrophotographic photoreceptor or of the surface of the intermediate transfer body are measured by using a microhardness measuring device Fischer scope H100V (manufactured by Fischer) under a 25° C./50% RH environment. In the Fischer scope H100V, an indenter is brought into abutment with a measuring object (the surface of the electrophotographic photoreceptor), a load is continuously applied to the indenter, and then a dent depth of the indenter under load is directly read, so a continuous hardness can be determined.

In the present invention, a Vickers four-sided pyramid diamond indenter having an angle between the opposite faces of 136° is used as the indenter. In addition, the final value of the load to be continuously applied to the indenter (final load) is 6 mN when the measuring object is the electrophotographic photoreceptor, or 0.1 mN when the measuring object is the intermediate transfer body. A time during which a state where a final load of 6 mN or 0.1 mN is applied to the indenter is held (holding time) is set to 0.1 second. In addition, the number of points of measurement is 273.

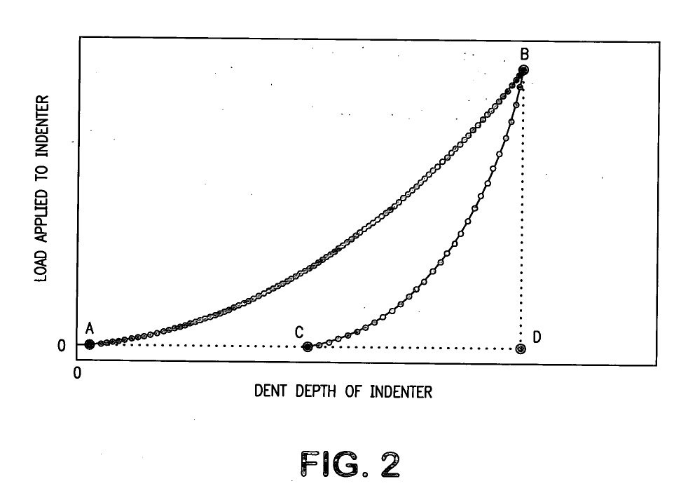

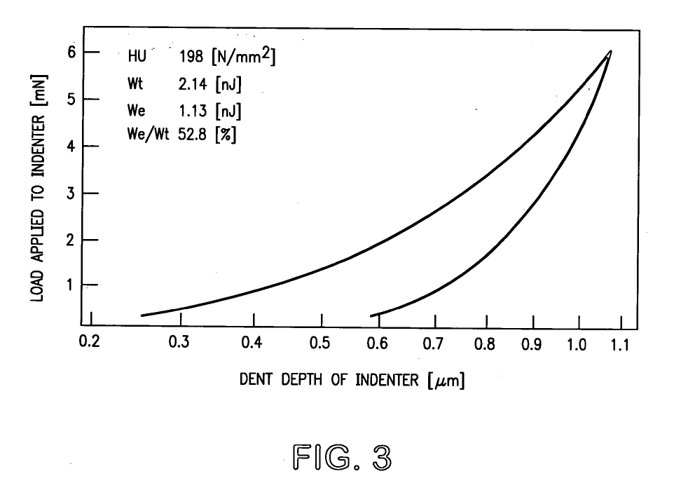

FIG. 2 shows the outline of an output chart of the Fischer scope H100V (manufactured by Fischer). In addition, FIG. 3 shows an example of the output chart of the Fischer scope H100V (manufactured by Fischer) when the electrophotographic photoreceptor to be used in the present invention is prepared as the measuring object. In each of FIGS. 2 and 3, the axis of ordinate indicates a load F (MN) applied to the indenter, while the axis of abscissas indicates a dent depth h (μm) of the indenter. FIG. 2 shows the result obtained when the load to be applied to the indenter is increased in a stepwise manner to show a maximum (A→B), and is then decreased in a stepwise manner (B→C). FIG. 3 shows the result obtained when the load to be applied to the indenter is increased in a stepwise manner to be finally 6 mN, and is then decreased in a stepwise manner.

The universal hardness value (HU) can be determined from the dent depth of the indenter when a final load of 6 mN or 0.1 mN is applied to the indenter by using the following equation. In the following equation, the universal hardness value (HU) means a universal hardness (universal hardness value (HU)), Ff means the final load, S_{f} means the surface area of a dented portion of the indenter when the final load is applied, and h_{f} means the dent depth of the indenter when the final load is applied.
HU=F_{f} [N]/Sf [mm²]=(6×10⁻³ or 0.1×10⁻³)/26.43×(h_{f}×10⁻³)²

In addition, the elastic deformation rate can be determined from a change in workload (energy) done by the indenter for the measuring object (the surface of the electrophotographic photoreceptor), that is, a change in energy due to an increase or decrease in load to the measuring object (the surface of the electrophotographic photoreceptor) of the indenter. Specifically, a value obtained by dividing an elastic deformation workload We by a total work Wt (We/Wt) is the elastic deformation rate. The total workload Wt corresponds to the area of a region surrounded by the lines A-B-D-A in FIG. 2, while the elastic deformation workload We corresponds to the area of a region surrounded by the lines C-B-D-C in FIG. 2.

Hereinafter, the electrophotographic photoreceptor used in the present invention and a method of producing the electrophotographic photoreceptor will be described in more detail.

To obtain an electrophotographic photoreceptor with a surface having a universal hardness value (HU) and an elastic deformation rate within the above ranges, it is effective to form a surface layer of the electrophotographic photoreceptor by polymerizing a hole transporting compound having a chain-polymerizable functional group. To achieve the same end, it is particularly effective to form the surface layer by polymerizing and cross-linking a hole transporting compound having two or more chain-polymerizable functional groups (in the same molecule). The surface layer of the electrophotographic photoreceptor refers to a layer placed on the outermost surface of the electrophotographic photoreceptor, in other words, a layer placed at a position most distant from the support.

First, a method of forming the surface layer by using a hole transporting compound having a chain-polymerizable functional group will be described more specifically.

The surface layer can be formed by: applying an application liquid for a surface layer containing a hole transporting compound having a chain-polymerizable functional group, a solvent, and, as required, a binder resin; polymerizing (and cross-linking) the hole transporting compound having a chain-polymerizable functional group; and curing the applied application liquid for a surface layer.

Each of the application methods including a dip applying method (a dip coating method), a spray coating method, a curtain coating method, and a spin coating method can be used when the application liquid for a surface layer is applied. Of those application methods, the dip applying method and the spray coating method are preferable from the viewpoints of efficiency and productivity.

Examples of a method of polymerizing (and cross-linking) the hole transporting compound having a chain-polymerizable functional group include a method using heat, light such as visible light or ultraviolet light, or a radial ray such as an electron ray or a γ ray. A polymerization initiator may be incorporated into the application liquid for a surface layer as required.

A method using a radial ray such as an electron ray or a γ ray, especially a method using an electron ray, is preferable as the method of polymerizing (and cross-linking) the hole transporting compound having a chain-polymerizable functional group. This is because polymerization by means of a radial ray does not particularly require a polymerization initiator. A three-dimensional matrix-shaped surface layer having an extremely high purity can be formed by polymerizing (and cross-linking) the hole transporting compound having a chain-polymerizable functional group without using a polymerization initiator. In this case, an electrophotographic photoreceptor exhibiting good electrophotographic characteristics can be obtained. In addition, polymerization by means of an electron ray out of the radial rays provides the electrophotographic photoreceptor with very small damage due to irradiation, so good electrophotographic characteristics can be expressed.

It is important to take conditions for irradiation with an electron ray into consideration in order to obtain the electrophotographic photoreceptor of the present invention having a universal hardness value (HU) and an elastic deformation rate within the above ranges by polymerizing (and cross-linking) the hole transporting compound having a chain-polymerizable functional group through irradiation with the electron ray.

Each of scanning type, electrocurtain type, broad beam type, pulse type, and laminar type accelerators can be used at the time of irradiation with an electron ray. An acceleration voltage is preferably 250 kV or less, particularly preferably 150 kV or less. An irradiation dose is preferably in the range of 0.1 to 100 Mrad, particularly preferably in the range of 0.5 to 20 Mrad. When the acceleration voltage or the irradiation dose is excessively large, electrical characteristics of the electrophotographic photoreceptor may deteriorate. When the irradiation dose is excessively small, the hole transporting compound having a chain-polymerizable functional group may be insufficiently polymerized (and cross-linked), and the application liquid for a surface layer may be insufficiently cured.

To promote the curing of the application liquid for a surface layer, it is preferable to heat an object to be irradiated (an object which is irradiated with an electron ray) at the time of the polymerization (and cross-linking) of the hole transporting compound having a chain-polymerizable functional group by means of the electron ray. The object to be irradiated may be heated at any one of the stages that of prior to the irradiation with the electron ray, during the irradiation, or after the irradiation. However, the temperature of the object to be irradiated is preferably kept constant while a radical of the hole transporting compound having a chain-polymerizable functional group is present. The heating is preferably performed in such a manner that the temperature of the object to be irradiated is in the range of room temperature to 250° C. (more preferably 50 to 150° C.). An excessively high heating temperature may cause a material for the electrophotographic photoreceptor to deteriorate. An excessively low heating temperature causes an effect obtained by heating to be poor. A heating time is preferably in the range of about several seconds to several tens of minutes, specifically 2 seconds to 30 minutes.

The irradiation with an electron ray and the heating of the object to be irradiated may be performed in anyone of the atmosphere of the air, an inert gas such as nitrogen or helium, or a vacuum. However, the irradiation and the heating are preferably performed in an inert gas or a vacuum because the deactivation of a radical due to oxygen can be suppressed.

In addition, the surface layer of the electrophotographic photoreceptor has a thickness of preferably 30 μm or less, more preferably 20 μm or less, more preferably 10 μm or less, more preferably 7 μm or less from the viewpoints of electrophotographic characteristics. On the other hand, the surface layer has a thickness of preferably 0.5 μm or more, more preferably 1 μm or more from the viewpoint of the durability of the electrophotographic photoreceptor.

In the present invention, the term “hole transporting compound having a chain-polymerizable functional group” refers to a compound in which a chain-polymerizable functional group chemically binds to part of the molecules of a hole transporting compound.

Generation reactions for polymers can be roughly classified into two polymerization reaction forms: chain polymerization and sequential polymerization, and chain polymerization in the present invention refers to the former polymerization reaction form. Specifically, chain polymerization refers to unsaturated polymerization, ring-opening polymerization, or isomerization polymerization, having a reaction form in which a reaction proceeds mainly via an intermediate such as a radical or an ion.

A chain-polymerizable functional group refers to a functional group capable of adopting the above reaction form. Hereinafter, examples of an unsaturated polymerizable functional group and a ring-opening-polymerizable functional group that can find use in a wide variety of applications will be described.

Unsaturated polymerization is a reaction in which an unsaturated group such as C═C, C—C, C═O, C═N, or C≡N (mainly C═C) is polymerized by a radical or anion. Hereinafter, specific examples of the unsaturated polymerizable group will be shown.

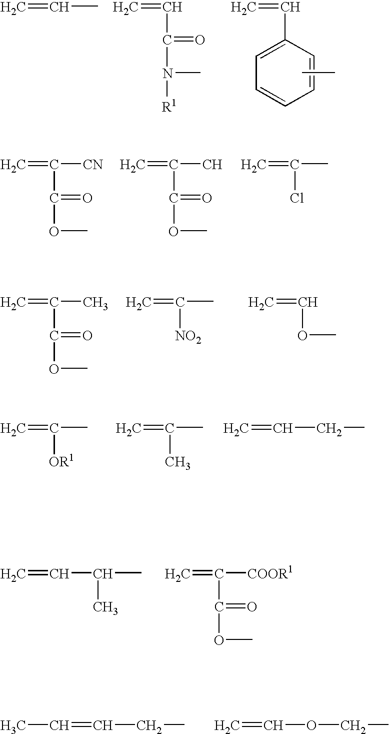

In the above formulae, R¹ represents a hydrogen atom, a substituted or unsubstituted alkyl group, a substituted or unsubstituted aryl group, a substituted or unsubstituted aralkyl group, or the like. Examples of the alkyl group include a methyl group, an ethyl group, and a propyl group. Examples of the aryl group include a phenyl group, a naphthyl group, and an anthryl group. Examples of the aralkyl group include a benzyl group and a phenethyl group.

Ring-opening polymerization is a reaction in which an unstable cyclic structure having distortion such as a carbon cycle, an oxo cycle, or a nitrogen heterocycle is subjected to ring-opening and, at the same time, repeatedly polymerized to produce a chain polymer. Inmost of ring-opening polymerization reactions, ions act as active species. Hereinafter, specific examples of the ring-opening-polymerizable functional group will be shown.

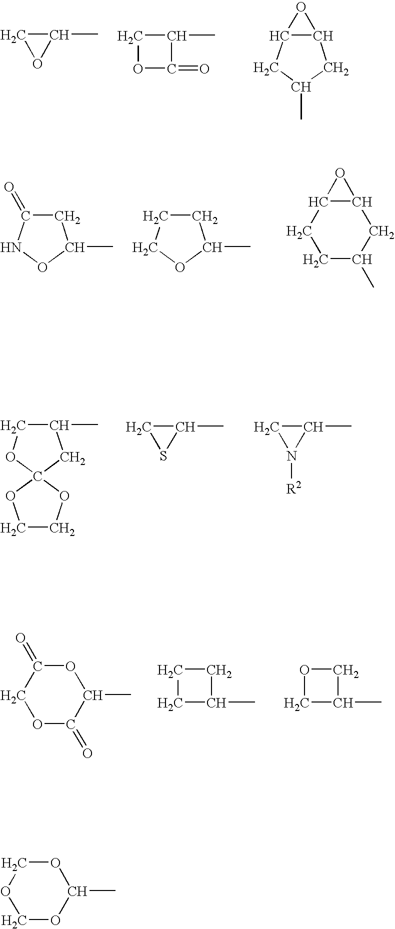

In the above formulae, R² represents a hydrogen atom, a substituted or unsubstituted alkyl group, a substituted or unsubstituted aryl group, a substituted or unsubstituted aralkyl group, or the like. Examples of the alkyl group include a methyl group, an ethyl group, and a propyl group. Examples of the aryl group include a phenyl group, a naphthyl group, and an anthryl group. Examples of the aralkyl group include a benzyl group and a phenethyl group.

Of the above-exemplified chain-polymerizable functional groups, chain-polymerizable functional groups having structures represented by the following formulae (1) to (3) are preferable.

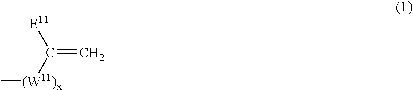

In the formulae (1), E¹¹ represents a hydrogen atom, a halogen atom, a substituted or unsubstituted alkyl group, a substituted or unsubstituted aryl group, a substituted or unsubstituted aralkyl group, a substituted or unsubstituted alkoxy group, a cyano group, a nitro group, —COOR¹¹, or —CONR¹²R¹³. W¹¹ represents a substituted or unsubstituted alkylene group, a substituted or unsubstituted arylene group, —COO—, —O—, —OO—, —S—, or —CONR¹⁴. R¹¹ to R¹⁴ each independently represent a hydrogen atom, a halogen atom, a substituted or unsubstituted alkyl group, a substituted or unsubstituted aryl group, or a substituted or unsubstituted aralkyl group. The subscript X represents 0 or 1. Examples of the halogen atom include a fluorine atom, a chlorine atom, and a bromine atom. Examples of the alkyl group include a methyl group, an ethyl group, a propyl group, and a butyl group. Examples of the aryl group include a phenyl group, a naphthyl group, an anthryl group, a pyrenyl group, a thiophenyl group, and a furyl group. Examples of the aralkyl group include a benzyl group, a phenethyl group, a naphthylmethyl group, a furfuryl group, and a thienyl group. Examples of the alkoxy group include a methoxy group, an ethoxy group, and a propoxy group. Examples of the alkylene group include a methylene group, an ethylene group, and a butylene group. Examples of the arylene group include a phenylene group, a naphthylene group, and an anthracenylene group.

Examples of a substituent which each of the above groups may have include: a halogen atom such as a fluorine atom, a chlorine atom, a bromine atom, or an iodine atom; an alkyl group such as a methyl group, an ethyl group, a propyl group, or a butyl group; an aryl group such as a phenyl group, a naphthyl group, an anthryl group, or a pyrenyl group; an aralkyl group such as a benzyl group, a phenethyl group, a naphthylmethyl group, a furfuryl group, or a thienyl group; an alkoxy group such as a methoxy group, an ethoxy group, or a propoxy group; an aryloxy group such as a phenoxy group or a naphthoxy group; a nitro group; a cyano group; and a hydroxyl group.

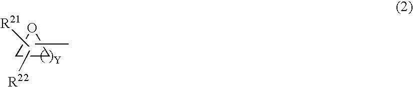

In the formulae (2), R²¹ and R²² each independently represent a hydrogen atom, a substituted or unsubstituted alkyl group, a substituted or unsubstituted aryl group, or a substituted or unsubstituted aralkyl group The subscript Y represents an integer of 1 to 10. Examples of the alkyl group include a methyl group, an ethyl group, a propyl group, and a butyl group. Examples of the aryl group include a phenyl group and a naphthyl group. Examples of the aralkyl group include a benzyl group and a phenethyl group.

Examples of a substituent which each of the above groups may have include: a halogen atom such as a fluorine atom, a chlorine atom, a bromine atom, or an iodine atom; an alkyl group such as a methyl group, an ethyl group, a propyl group, or a butyl group; an aryl group such as a phenyl group, a naphthyl group, an anthryl group, or a pyrenyl group; an aralkyl group such as a benzyl group, a phenethyl group, a naphthylmethyl group, a furfuryl group, or a thienyl group; an alkoxy group such as a methoxy group, an ethoxy group, or a propoxy group; and an aryloxy group such as a phenoxy group or a naphthoxy group.

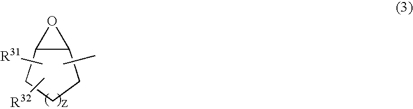

In the formulae (3), R³¹ and R³² each independently represent a hydrogen atom, a substituted or unsubstituted alkyl group, a substituted or unsubstituted aryl group, or a substituted or unsubstituted aralkyl group. The subscript Z represents an integer of 1 to 10. Examples of the alkyl group include a methyl group, an ethyl group, a propyl group, and a butyl group. Examples of the aryl group include a phenyl group and a naphthyl group. Examples of the aralkyl group include a benzyl group and a phenethyl group.

Examples of a substituent which each of the above groups may have include: a halogen atom such as a fluorine atom, a chlorine atom, a bromine atom, or an iodine atom; an alkyl group such as a methyl group, an ethyl group, a propyl group, or a butyl group; an aryl group such as a phenyl group, a naphthyl group, an anthryl group, or a pyrenyl group; an aralkyl group such as a benzyl group, a phenethyl group, a naphthylmethyl group, a furfuryl group, or a thienyl group; an alkoxy group such as a methoxy group, an ethoxy group, or a propoxy group; and an aryloxy group such as a phenoxy group or a naphthoxy group.

Of the chain-polymerizable functional groups having the structures represented by the above formulae (1) to (3), chain-polymerizable functional groups having structures represented by the following formulae (P-1) to (P-11) are more preferable.

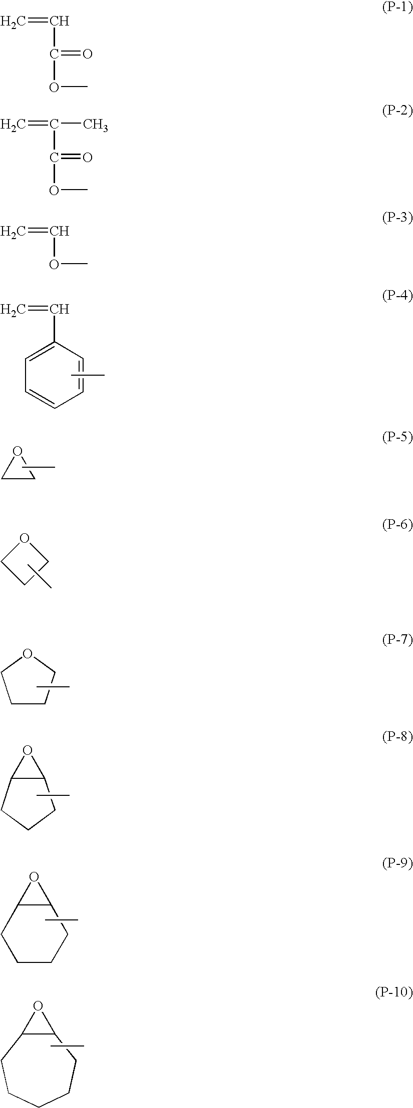

Of the chain-polymerizable functional groups having the structures represented by the above formulae (P-1) to (P-11), the chain-polymerizable functional group having the structure represented by the above formulae (P-1), that is, an acryloyloxy group, and the chain-polymerizable functional group having the structure represented by the above formulae (P-2), that is, a methacryloyloxy group are still more preferable.

In the present invention, out of the above hole transporting compounds each having a chain-polymerizable functional group, a hole transporting compound having two or more chain-polymerizable functional groups (in the same molecule) is preferable. Hereinafter, specific examples of the hole transporting compound having two or more chain-polymerizable functional groups will be shown.
(P⁴¹)ₐ-A⁴¹-[R⁴¹—(P⁴²)_{d}]_{b} (4)

In the formulae (4), P⁴¹ and P⁴² each independently represent a chain-polymerizable functional group. R⁴¹ represents a divalent group. A⁴¹ represents a hole transporting group. The subscripts a, b, and d each independently represent an integer of 0 or more, provided that a+b×d is 2 or more. When a is 2 or more, a numbers of P⁴¹ may be identical to or different from each other. When b is 2 or more, b numbers of [R⁴¹—(P⁴²)_{d}] may be identical to or different from each other. When d is 2 or more, d numbers of P⁴² may be identical to or different from each other.

Examples of a compound obtained by replacing all of (P⁴¹)ₐ and [R⁴¹—(P⁴²)_{d}]_{b} in the formula (4) with hydrogen atoms include an oxazole derivative, an oxadiazole derivative, an imidazole derivative, a triarylamine derivative (such as triphenylamine), 9-(p-diethylaminostyryl)anthracene, 1,1-bis-(4-dibenzylaminophenyl)propane, styrylanthracene, styrylpyrazoline, a phenylhydrazone, a thiazole derivative, a triazole derivative, a phenazine derivative, an acrizine derivative, a benzofuran derivative, a benzimidazole derivative, a thiophene derivative, and an N-phenylcarbazole derivative. Of the compounds each of which is obtained by replacing all of (P⁴¹)ₐ and [R⁴¹—(P⁴²)_{d}]_{b} in the formula (4) with hydrogen atoms, compounds each having a structure represented by the following formula (5) are preferable.

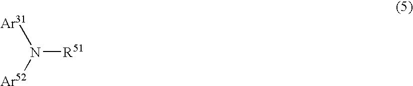

In the formulae (5), R⁵¹ represents a substituted or unsubstituted alkyl group, a substituted or unsubstituted aryl group, or a substituted or unsubstituted aralkyl group. Ar⁵¹ and Ar⁵² each independently represent a substituted or unsubstituted aryl group. Each of R⁵¹, Ar⁵¹, and Ar⁵² may bind to N (nitrogen atom) directly or via an alkylene group (such as a methyl group, an ethyl group, or a propylene group), a hetero atom (such as an oxygen atom or a sulfur atom), or —CH═CH—. The alkyl group is preferably one having 1 to 10 carbon atoms, and examples of such a group include a methyl group, an ethyl group, a propyl group, and a butyl group. Examples of the aryl group include a phenyl group, a naphthyl group, an anthryl group, a phenanthryl group, a pyrenyl group, a thiophenyl group, a furyl group, a pyridyl group, a quionolyl group, a benzoquinolyl group, a carbazolyl group, a phenothiadinyl group, a benzofuryl group, a benzothiophenyl group, a dibenzofuryl group, and a dibenzothiophenyl group. Examples of the aralkyl group include a benzyl group, a phenethyl group, a naphthylmethyl group, a furfuryl group, and a thienyl group. R⁵¹ in the formula (5) is preferably a substituted or unsubstituted aryl group.

Examples of a substituent which each of the above groups may have include: a halogen atom such as a fluorine atom, a chlorine atom, a bromine atom, or an iodine atom; an alkyl group such as a methyl group, an ethyl group, a propyl group, or a butyl group; an aryl group such as a phenyl group, a naphthyl group, an anthryl group, or a pyrenyl group; an aralkyl group such as a benzyl group, a phenethyl group, a naphthylmethyl group, a furfuryl group, or a thienyl group; an alkoxy group such as a methoxy group, an ethoxy group, or a propoxy group; an aryloxy group such as a phenoxy group or a naphthoxy group; a substituted amino group such as a dimethylamino group, a diethylamino group, a dibenzylamino group, a diphenylamino group, or a di(p-tolyl)amino group; an arylvinyl group such as a styryl group or a naphthylvinyl group; a nitro group; a cyano group; and a hydroxyl group.

Examples of the divalent group represented by R⁴¹ in the formula (4) include a substituted or unsubstituted alkylene group, a substituted or unsubstituted arylene group, —CR⁴¹¹═CR¹¹²— (where R⁴¹¹ and R⁴¹² each independently represent a hydrogen atom, a substituted or unsubstituted alkyl group, or a substituted or unsubstituted aryl group), —CO—, —SO—, —SO₂—, an oxygen atom, a sulfur atom, and a combination of those. Of those, a divalent group having a structure represented by the following formula (6) is preferable, and a divalent group having a structure represented by the following formula (7) is more preferable.
—(X⁶¹)ₚ₆—(Ar⁶¹)ₚ₆—(X⁶²)ᵣ₆—(Ar⁶²)ₛ₆—(X⁶³)ₜ6— (6)
—(X⁷¹)ₚ₇—(Ar⁷¹)_{q7}—(X⁷²)ᵣ₇— (7)

In the formulae (6), X⁶¹ to X⁶³ each independently represent a substituted or unsubstituted alkylene group, —(CR⁶¹═CR⁶²)ₙ₆— (where R⁶¹ and R⁶² each independently represent a hydrogen atom, a substituted or unsubstituted alkyl group, or a substituted or unsubstituted aryl group, and the subscript n6 represents an integer of 1 or more (preferably 5 or less)), —CO—, —SO—, —SO₂—, an oxygen atom, or a sulfur atom. Ar⁶¹ and Ar⁶² each independently represent a substituted or unsubstituted arylene group The subscripts p6, q6, r6, s6, and t6 each independently represent an integer of 0 or more (preferably 10 or less, more preferably 5 or less), provided that all of p6, q6, r6, s6, and t6 cannot be 0 simultaneously The alkylene group is preferably one having 1 to 20 carbon atoms, particularly preferably one having 1 to 10 carbon atoms, and examples of such a group include a methylene group, an ethylene group, and a propylene group. Examples of the arylene group include a divalent group obtained by removing two hydrogen atoms from benzene, naphthalene, anthracene, phenanthrene, pyrene, benzothiophene, pyridine, quinoline, benzoquinoline, carbazole, phenothiazine, benzofuran, benzothiophene, dibenzofuran, dibenzothiphene, or the like. Examples of the alkyl group include a methyl group, an ethyl group, and a propyl group. Examples of the aryl group include a phenyl group, a naphthyl group, and a thiophenyl group.

Examples of a substituent which each of the above groups may have include: a halogen atom such as a fluorine atom, a chlorine atom, a bromine atom, or an iodine atom; an alkyl group such as a methyl group, an ethyl group, a propyl group, or a butyl group; an aryl group such as a phenyl group, a naphthyl group, an anthryl group, or a pyrenyl group; an aralkyl group such as a benzyl group, a phenethyl group, a naphthylmethyl group, a furfuryl group, or a thienyl group; an alkoxy group such as a methoxy group, an ethoxy group, or a propoxy group; an aryloxy group-such as a phenoxy group or a naphthoxy group; a substituted amino group such as a dimethylamino group, a diethylamino group, a dibenzylamino group, a diphenylamino group, or a di(p-tolyl)amino group; an arylvinyl group such as a styryl group or a naphthylvinyl group; a nitro group; a cyano group; and a hydroxyl group.

In the formulae (7), X⁷¹ and X⁷² each independently represent a substituted or unsubstituted alkylene group, —(CR⁷¹═CR⁷²)— (where R⁷¹ and R⁷² each independently represent a hydrogen atom, a substituted or unsubstituted alkyl group, or a substituted or unsubstituted aryl group, and the subscript n7 represents an integer of 1 or more (preferably 5 or less)), —CO—, or an oxygen atom. Ar⁷¹ represents a substituted or unsubstituted arylene group. The subscripts p7, q7, and r7 each independently represent an integer of 0 or more (preferably 10 or less, more preferably 5 or less), provided that all of p7, q7, and r7 cannot be 0 simultaneously. The alkylene group is preferably one having 1 to 20 carbon atoms, particularly preferably one having 1 to 10 carbon atoms, and examples of such a group include a methylene group, an ethylene group, and a propylene group. Examples of the arylene group include a divalent group obtained by removing two hydrogen atoms from benzene, naphthalene, anthracene, phenanthrene, pyrene, benzothiophene, pyridine, quinoline, benzoquinoline, carbazole, phenothiazine, benzofuran, benzothiophene, dibenzofuran, dibenzothiphene, or the like. Examples of the alkyl group include a methyl group, an ethyl group, and a propyl group. Examples of the aryl group include a phenyl group, a naphthyl group, and a thiophenyl group.

Examples of a substituent which each of the above groups may have include: a halogen atom such as a fluorine atom, a chlorine atom, a bromine atom, or an iodine atom; an alkyl group such as a methyl group, an ethyl group, a propyl group, or a butyl group; an aryl group such as a phenyl group, a naphthyl group, an anthryl group, or a pyrenyl group; an aralkyl group such as a benzyl group, a phenethyl group, a naphthylmethyl group, a furfuryl group, or a thienyl group; an alkoxy group such as a methoxy group, an ethoxy group, or a propoxy group; an aryloxy group such as a phenoxy group or a naphthoxy group; a substituted amino group such as a dimethylamino group, a diethylamino group, a dibenzylamino group, a diphenylamino group, or a di(p-tolyl)amino group; an arylvinyl group such as a styryl group or a naphthylvinyl group; a nitro group; a cyano group; and a hydroxyl group.

Hereinafter, preferable examples (compound examples) of the hole transporting compound having two or more chain-polymerizable functional group will be shown.

| No. | Compound example |
|---|---|
| 1 | 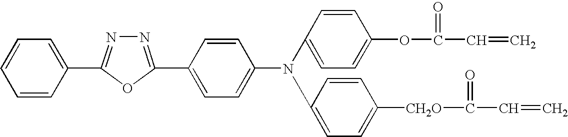 |
| 2 | 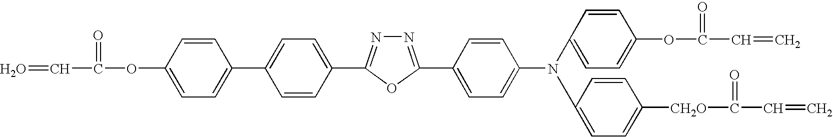 |
| 3 | 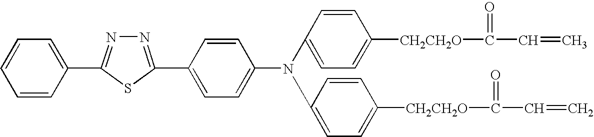 |
| 4 | 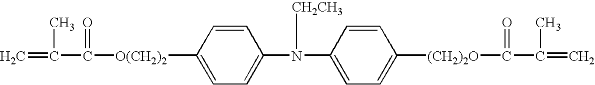 |
| 5 | 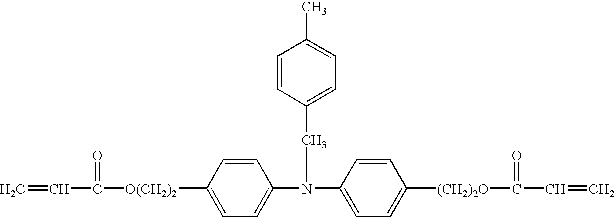 |
| 6 | 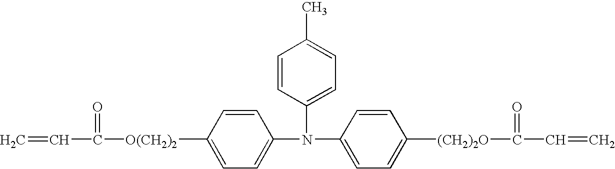 |
| 7 | 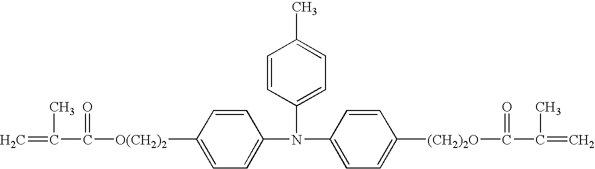 |
| 8 | 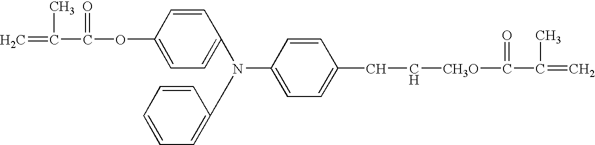 |
| 9 | 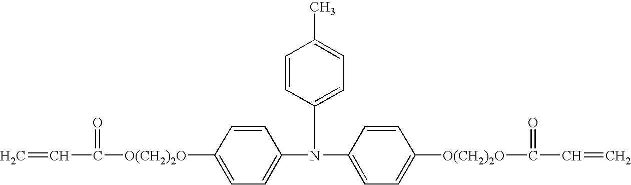 |
| 10 | 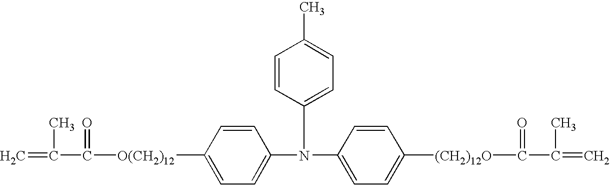 |
| 11 | 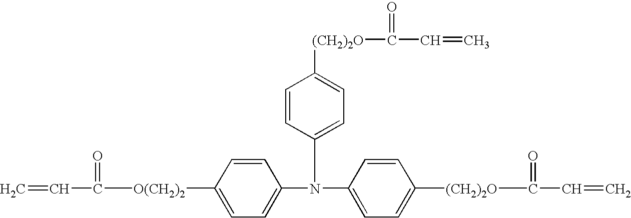 |
| 12 | 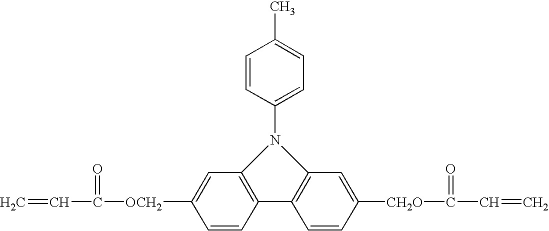 |
| 13 | 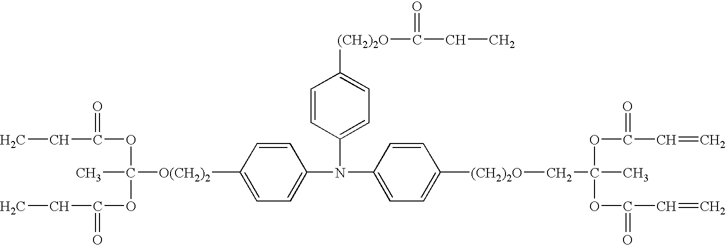 |
| 14 | 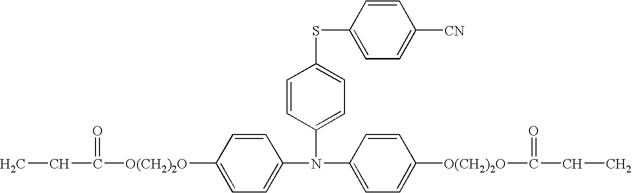 |
| 15 | 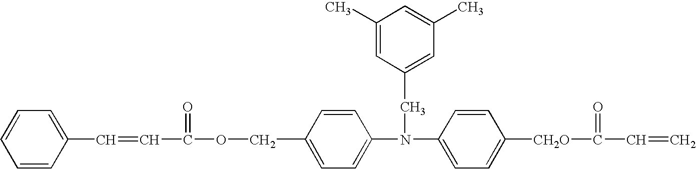 |
| 16 | 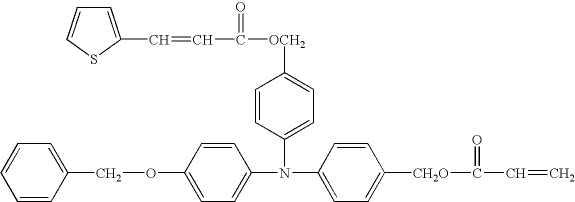 |
| 17 | 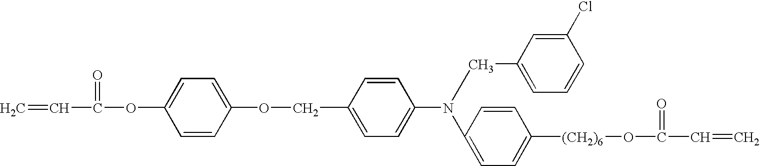 |
| 18 | 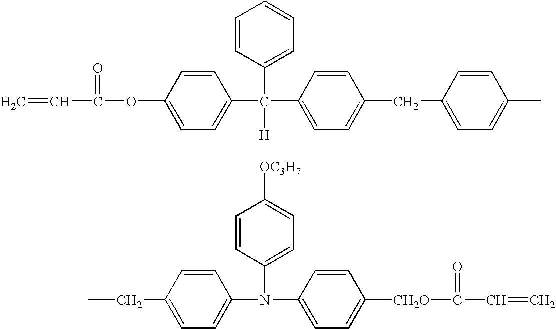 |
| 19 | 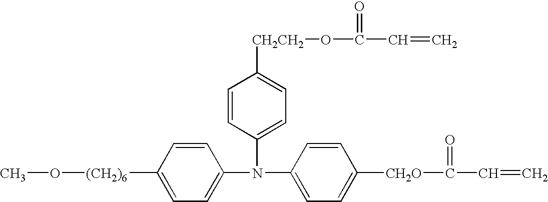 |
| 20 | 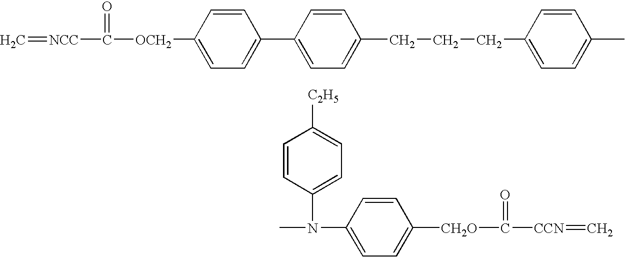 |
| 21 | 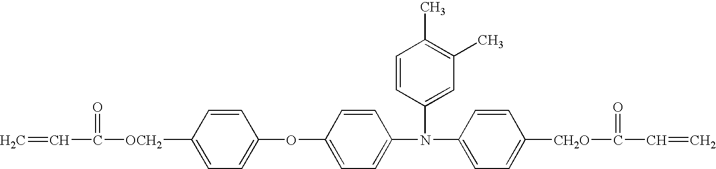 |
| 22 | 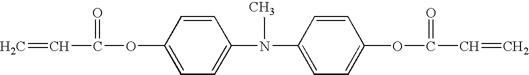 |
| 23 | 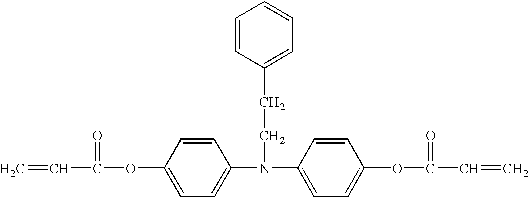 |
| 24 | 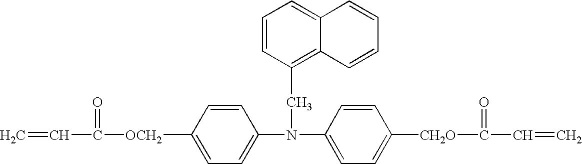 |
| 25 | 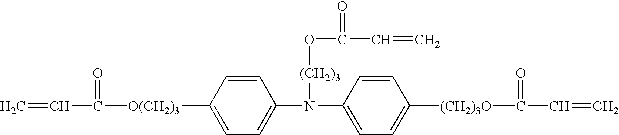 |
| 26 | 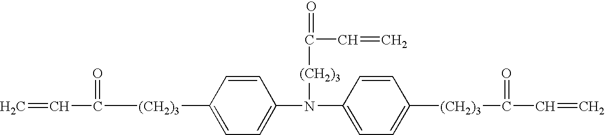 |
| 27 | 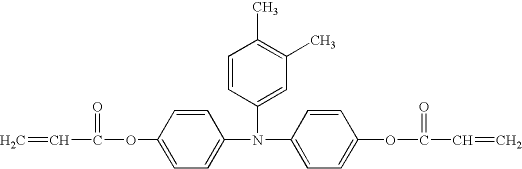 |
| 28 | 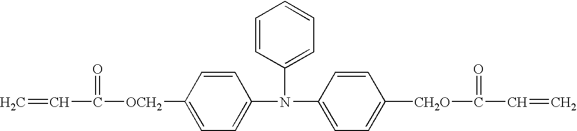 |
| 29 | 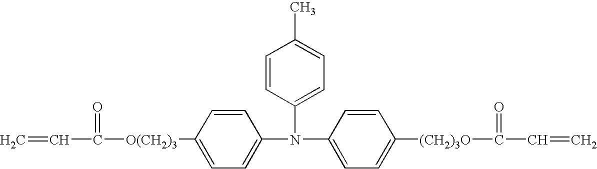 |
| 30 | 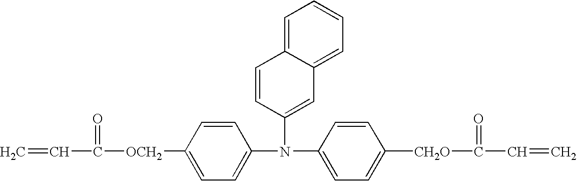 |
| 31 | 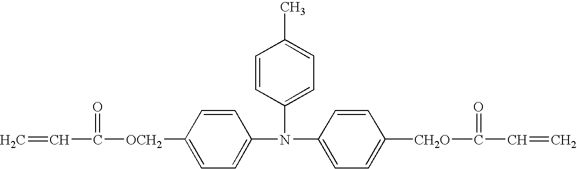 |
| 32 | 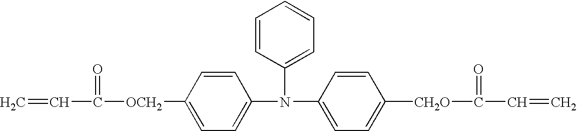 |
| 33 | 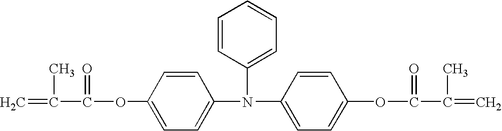 |
| 34 | 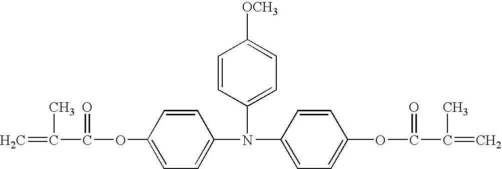 |
| 35 | 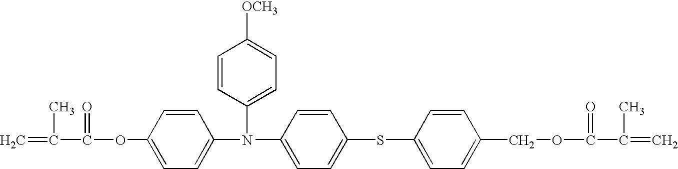 |
| 36 | 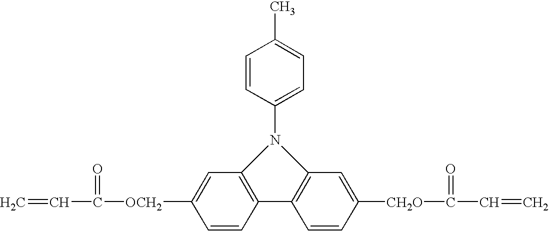 |
| 37 | 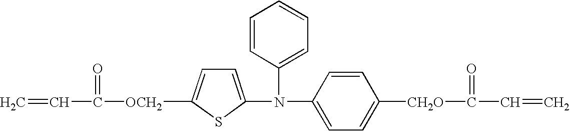 |
| 38 | 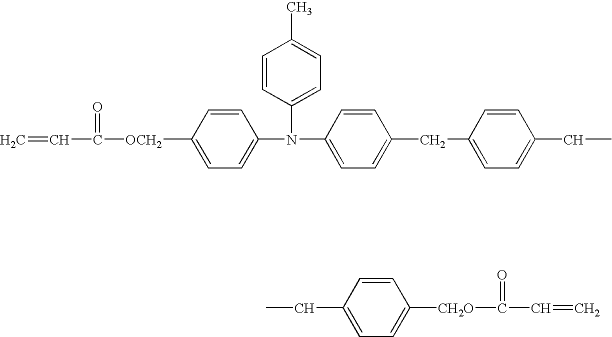 |
| 39 | 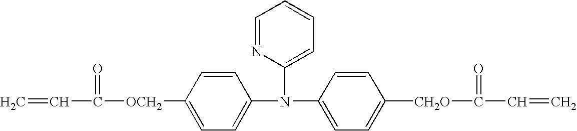 |
| 40 | 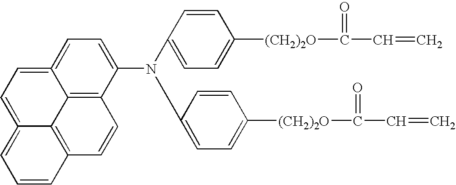 |
| 41 | 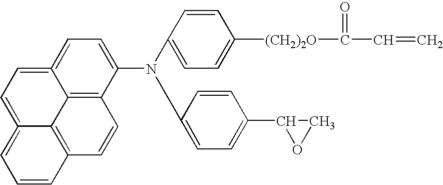 |
| 42 | 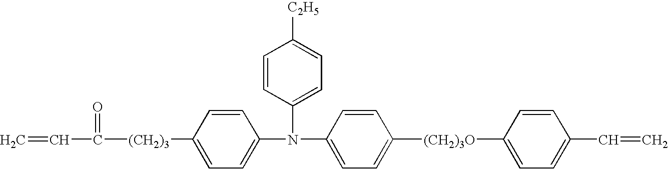 |
| 43 | 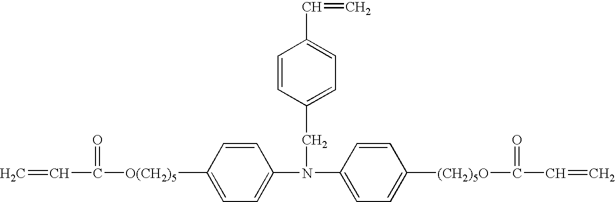 |
| 44 | 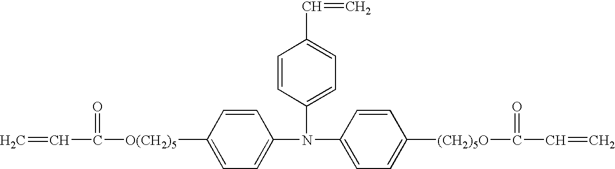 |
| 45 | 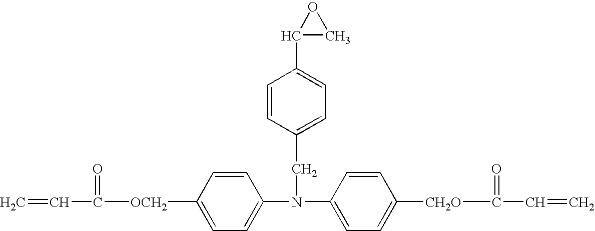 |
| 46 | 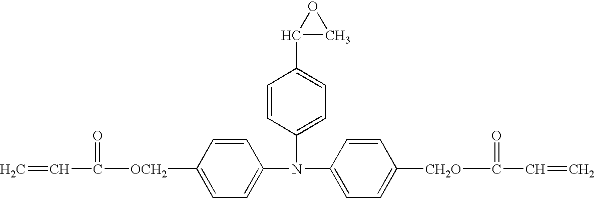 |
| 47 | 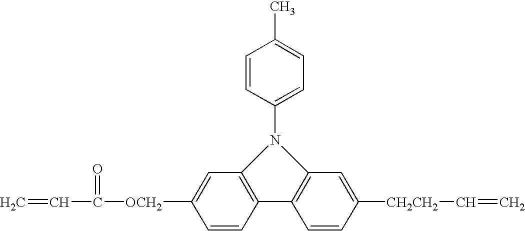 |
| 48 | 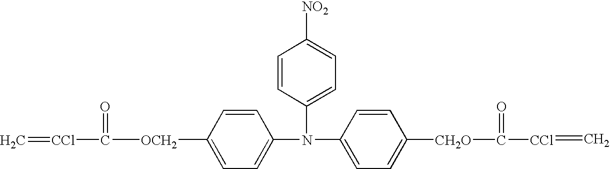 |
| 49 | 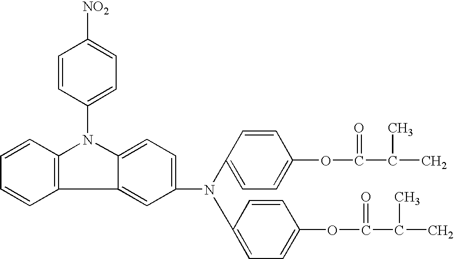 |
| 50 | 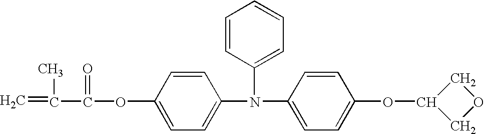 |
| 51 | 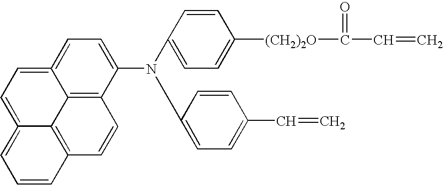 |
| 52 | 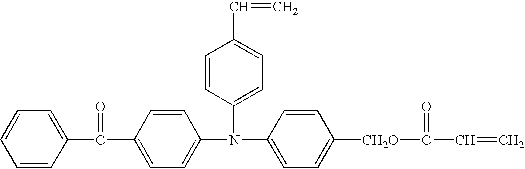 |
| 53 | 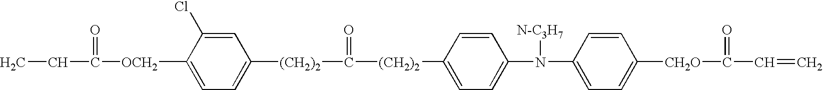 |
| 54 | 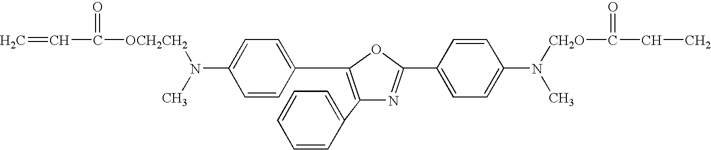 |
| 55 | 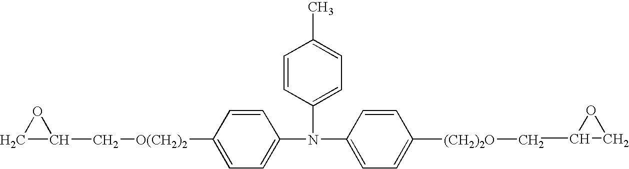 |
| 56 | 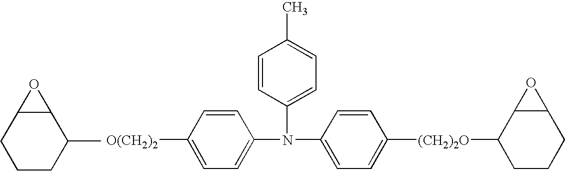 |
| 57 | 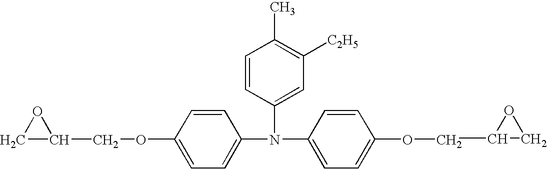 |
| 58 | 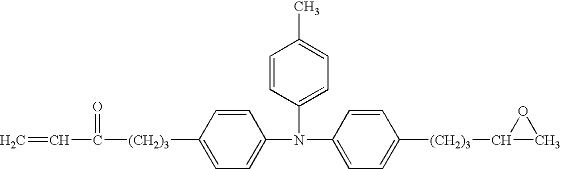 |
| 59 | 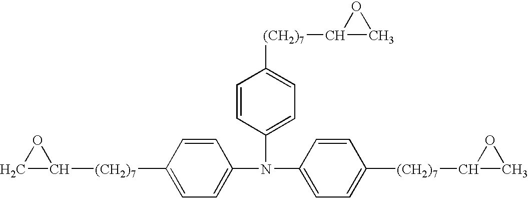 |
| 60 | 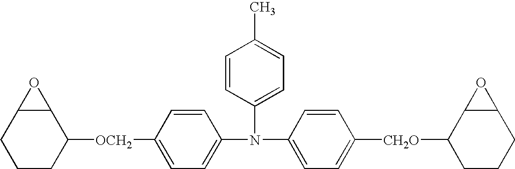 |
| 61 | 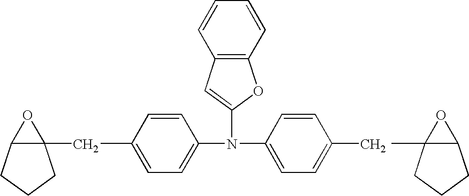 |
| 62 | 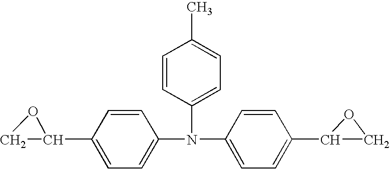 |
| 63 | 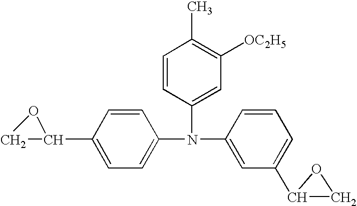 |
| 64 | 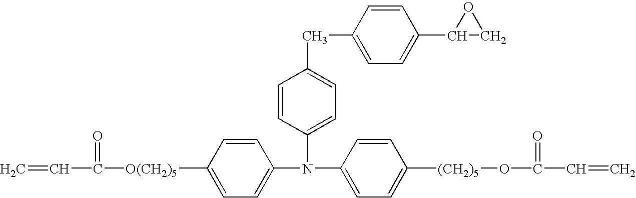 |
| 65 | 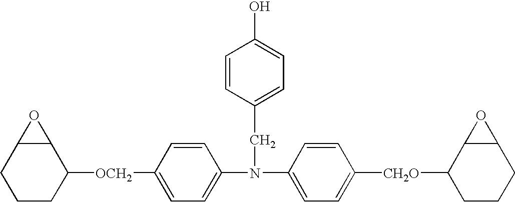 |
| 66 | 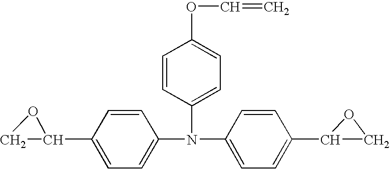 |
| 67 | 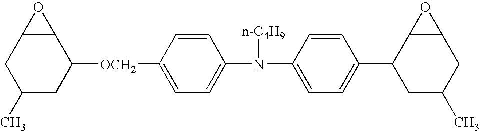 |
| 68 | 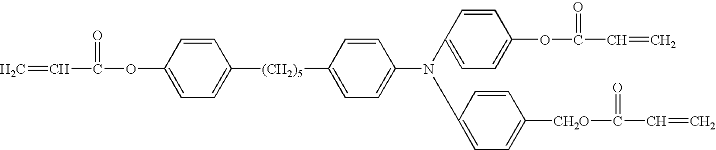 |
| 69 | 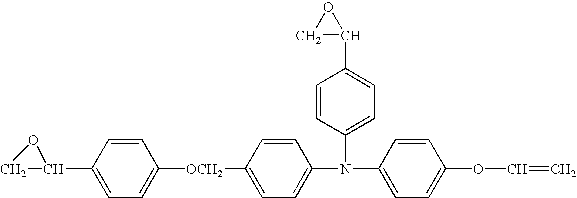 |
| 70 | 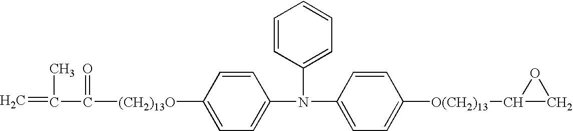 |
| 71 | 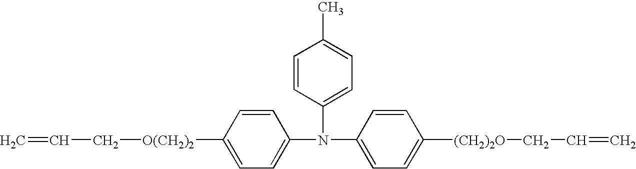 |
| 72 | 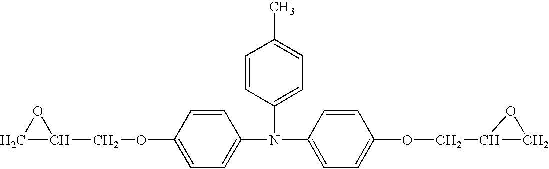 |
| 73 | 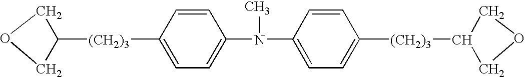 |
| 74 | 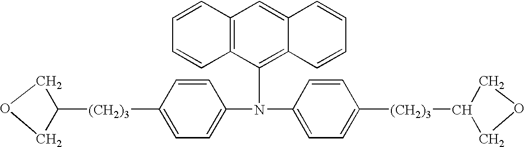 |
| 75 | 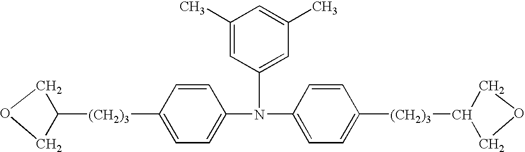 |
| 76 | 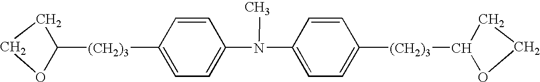 |
| 77 | 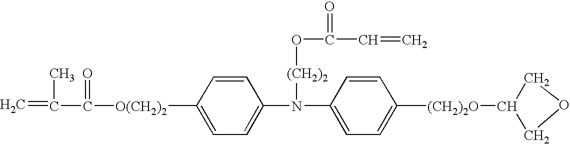 |
| 78 | 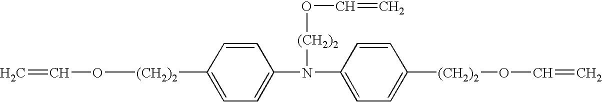 |
| 79 | 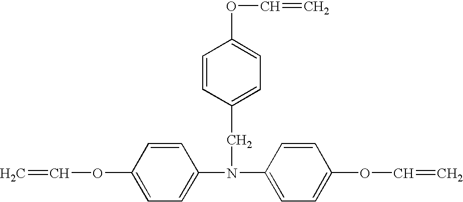 |
| 80 | 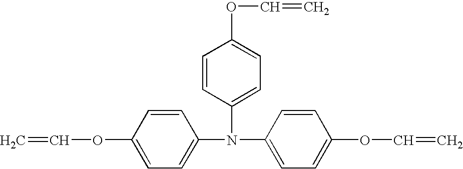 |
| 81 | 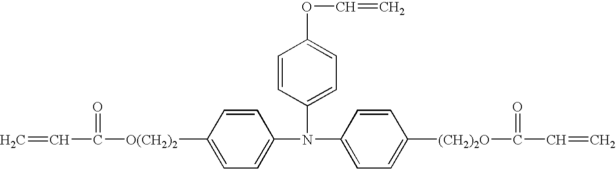 |
| 82 | 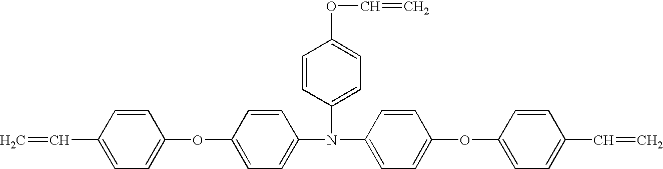 |
| 83 | 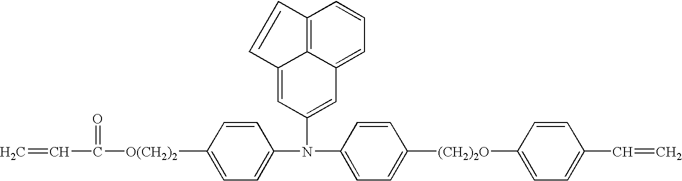 |
| 84 | 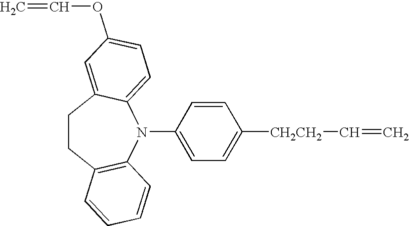 |
| 85 | 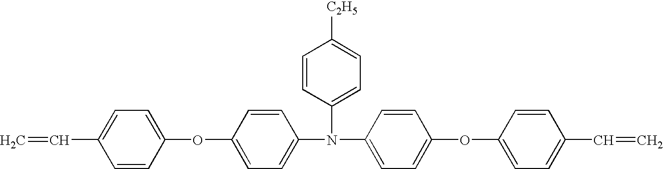 |
| 86 | 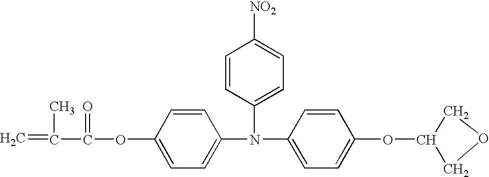 |
| 87 | 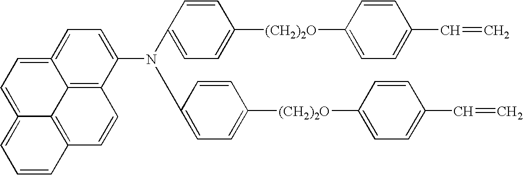 |
| 88 | 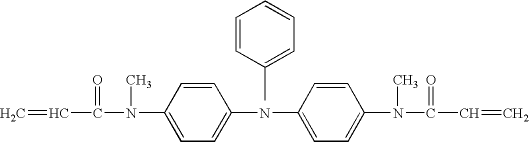 |
| 89 | 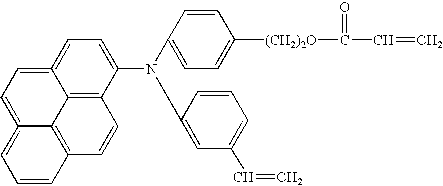 |
| 90 | 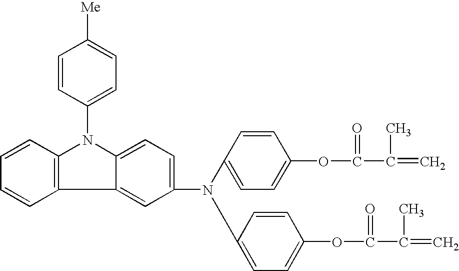 |
| 91 | 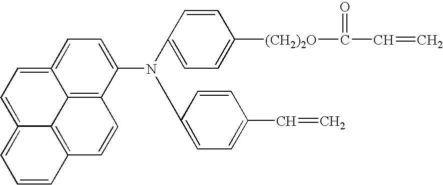 |
| 92 | 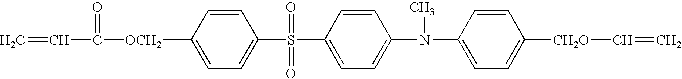 |
| 93 | 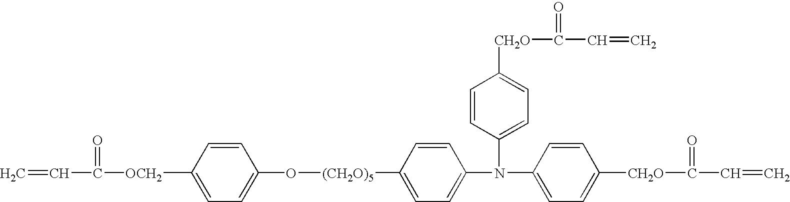 |
| 94 | 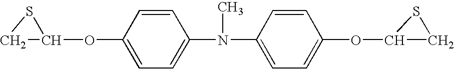 |
| 95 | 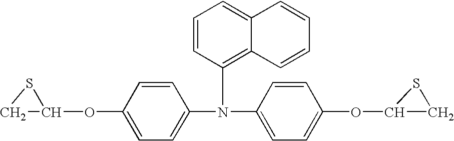 |
| 96 | 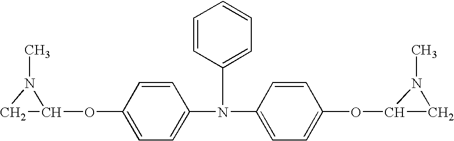 |
| 97 | 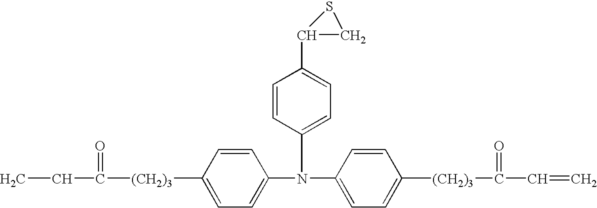 |
| 98 | 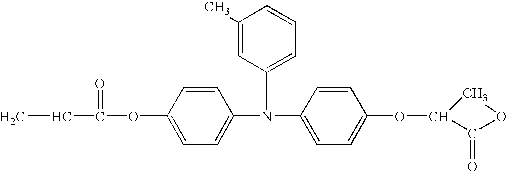 |
| 99 | 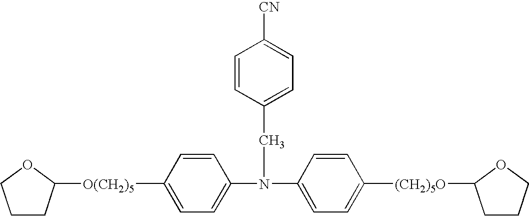 |
| 100 | 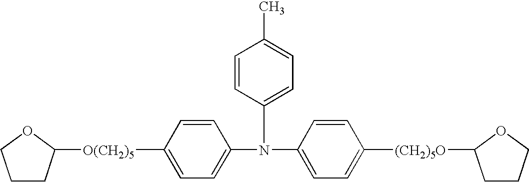 |
| 101 | 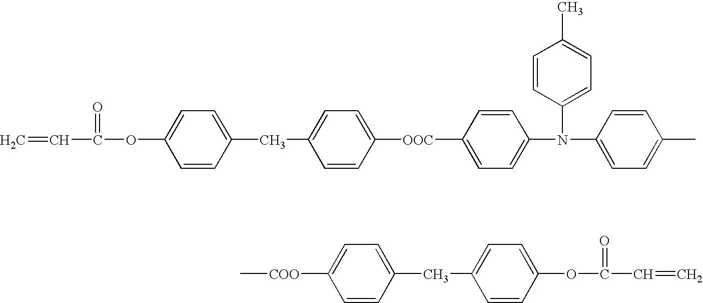 |
| 102 | 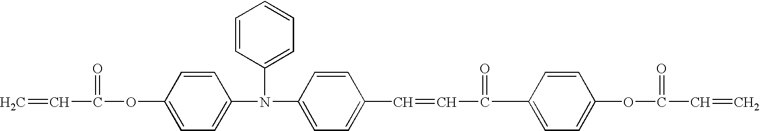 |
| 103 | 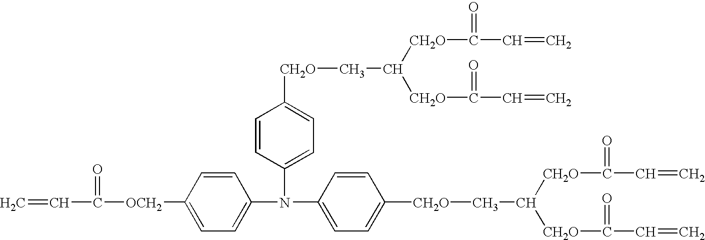 |
| 104 | 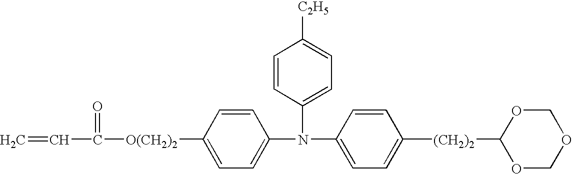 |
| 105 | 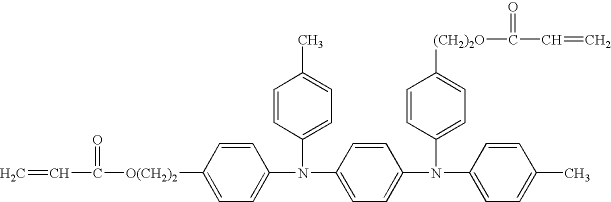 |
| 106 | 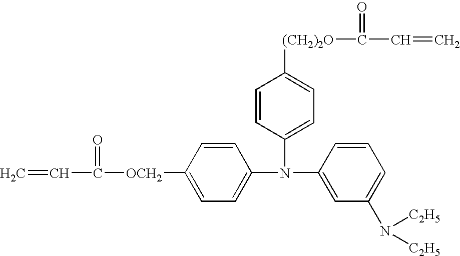 |
| 107 | 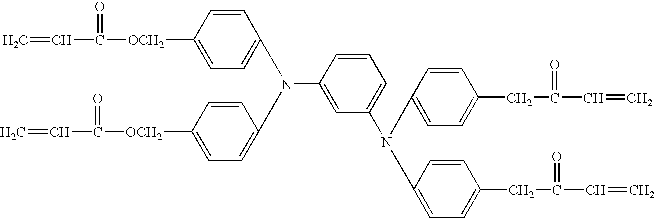 |
| 108 | 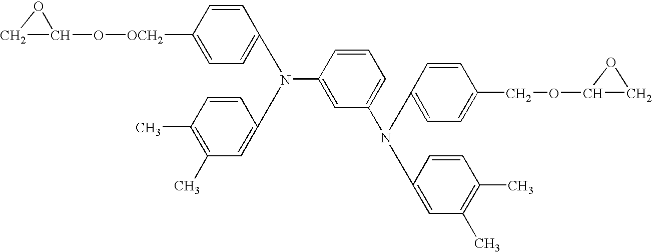 |
| 109 | 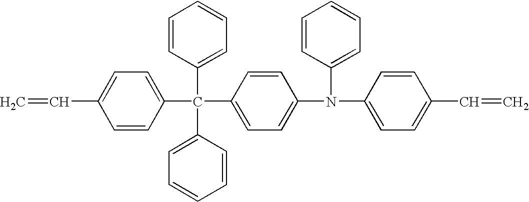 |
| 110 | 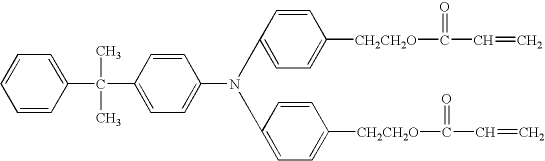 |
| 111 | 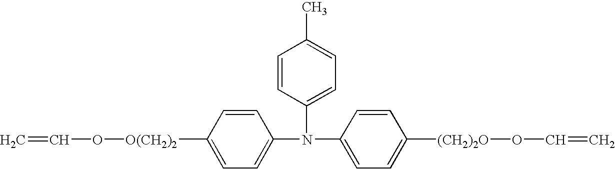 |
| 112 | 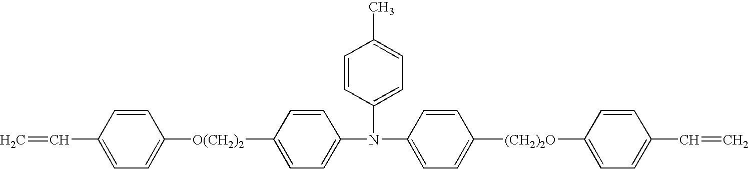 |
| 113 | 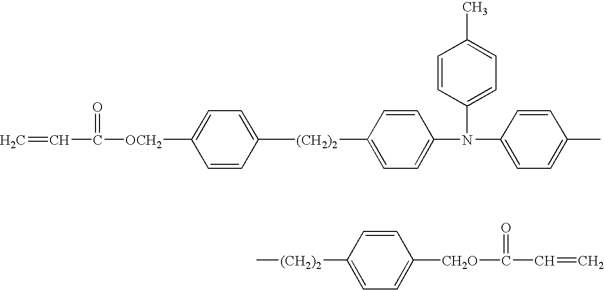 |
| 114 | 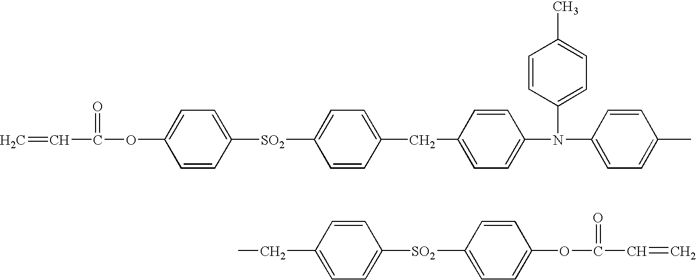 |
| 115 | 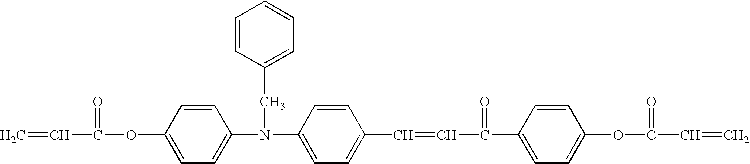 |
| 116 | 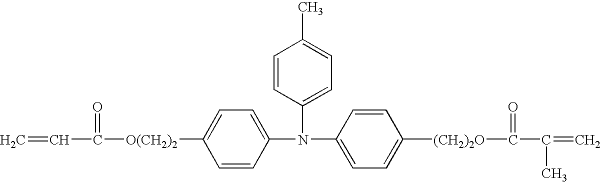 |
| 117 | 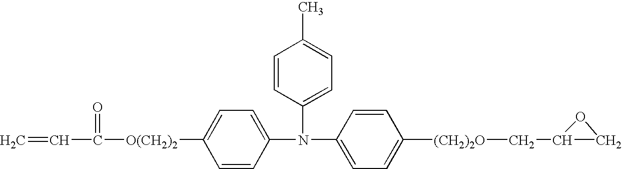 |
| 118 | 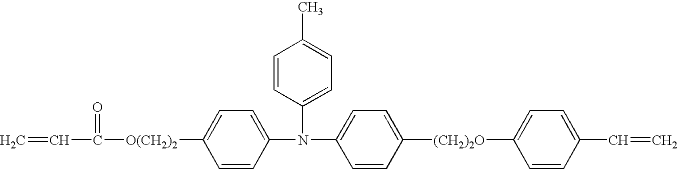 |
| 119 | 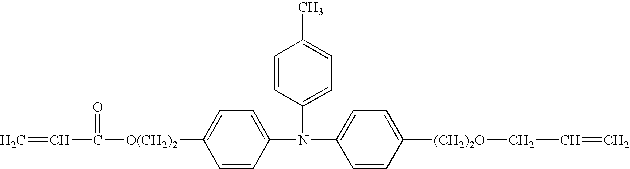 |

The hole transporting compound having a chain-polymerizable functional group to be used in the present invention can be synthesized by using the method described in JP 2000-66424 A, U.S. Pat. No. 6,180,303 or the like.

Next, the electrophotographic photoreceptor of the present invention including the surface layer and other layers will be described in more detail.

As described above, the electrophotographic photoreceptor of the present invention is an electrophotographic photoreceptor having a photosensitive layer on a support.

The photosensitive layer may be a monolayer type photosensitive layer containing a charge transporting substance and a charge generating substance in the same layer, or may be a laminated type (function separating type) photosensitive layer separated into a charge generating layer containing a charge generating substance and a charge transporting layer containing a charge transporting substance. However, the laminated type photosensitive layer is preferable from the viewpoints of electrophotographic characteristics. In addition, laminated type photosensitive layers can be classified into: a forward laminated type photosensitive layer in which a charge generating layer and a charge transporting layer are laminated in this order from a support side; and a reverse laminated type photosensitive layer in which a charge transporting layer and a charge generating layer are laminated in this order from a support side. However, the forward laminated type photosensitive layer is preferable from the viewpoints of electrophotographic characteristics. In addition, the charge generating layer may be of a laminated structure, and the charge transporting layer may be of a laminated structure.

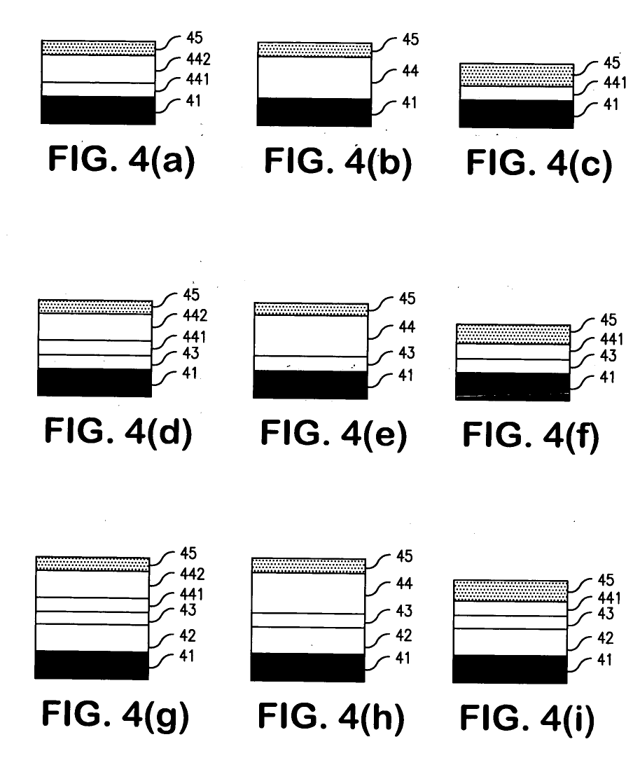

FIGS. 4(a) to 4(i) each show an example of a layer structure of the electrophotographic photoreceptor of the present invention.

In an electrophotographic photoreceptor having a layer structure shown in FIG. 4(a), a layer 441 containing a charge generating substance (a charge generating layer) and a layer 442 containing a charge transporting substance (a first charge transporting layer) are arranged in this order on a support 41. Furthermore, a layer 45 formed by polymerizing a hole transporting compound having a chain-polymerizable functional group (a second charge transporting layer) is arranged as a surface layer on the layer 442.

In an electrophotographic photoreceptor having a layer structure shown in FIG. 4(b), a layer 44 containing a charge generating substance and a charge transporting substance is arranged on a support 41. Furthermore, a layer 45 formed by polymerizing a hole transporting compound having a chain-polymerizable functional group is arranged as a surface layer on the layer 44.

In an electrophotographic photoreceptor having a layer structure shown in FIG. 4(c), a layer 441 containing a charge generating substance (a charge generating layer) is arranged on a support 41. Furthermore, a layer 45 formed by polymerizing a hole transporting compound having a chain-polymerizable functional group is arranged as a surface layer on the layer 441.

In addition, as shown in each of FIGS. 4(d) to 4(i), an intermediate layer (also referred to as “underlayer”) 43 having a barrier function or an adhesion function, a conductive layer 42 intended for, for example, prevention of interference fringes, or the like may be arranged between a support 41 and a layer 441 containing a charge generating substance (a charge generating layer) or a layer 44 containing a charge generating substance and a charge transporting substance.

Any one of the other layer structures can be adopted as long as the surface of the electrophotographic photoreceptor has a universal hardness value (HU) and an elastic deformation rate within the above ranges. However, when the surface layer of the electrophotographic photoreceptor is a layer formed by polymerizing a hole transporting compound having a chain-polymerizable functional group, each of the layer structures shown in FIGS. 4(a), 4(d), and 4(g) out of the layer structures shown in FIGS. 4(a) to 4(i) is preferable.

The support is not limited as long as it is conductive (a conductive support) and does not affect the measurement of the harness of the surface of the electrophotographic photoreceptor. For example, a support made of a metal (alloy) such as aluminum, copper, chromium, nickel, zinc, or stainless steel can be used. A support made of any of the above-mentioned metals having a layer coated with aluminum, an aluminum alloy, an indium oxide-tin oxide alloy, or the like by means of vacuum deposition, or a plastic support can be also used. A support obtained by impregnating plastic or paper with a conductive particle such as carbon black, a tin oxide particle, a titanium oxide particle, or a silver particle together with an appropriate binder resin, a plastic support having a conductive binder resin, or the like can be also used. Examples of the shape of the support include a cylindrical shape (drum shape) and a belt shape. However, the cylindrical shape is preferable.

In addition, the surface of the support may be subjected to a cutting treatment, a surface roughening treatment, an alumite treatment, or the like for the purpose of preventing interference fringes due to the scattering of laser light or the like, and for other purposes.

As described above, a conductive layer intended to prevent interference fringes due to the scattering of laser light or the like or to cover a flaw on the support may be arranged between the support and the photosensitive layer (including the charge generating layer and the charge transporting layer) or an intermediate layer to be described later.

The conductive layer can be formed by dispersing a conductive particle such as carbon black, a metal particle, or a metal oxide particle into a binder resin.

The thickness of the conductive layer is preferably in the range of 1 to 40 μm, particularly preferably in the range of 2 to 20 μm.

In addition, as described above, an intermediate layer having a barrier function or an adhesion function may be arranged between the support or the conductive layer and the photosensitive layer (including the charge generating layer and the charge transporting layer). The intermediate layer is formed for, for example, improving adhesiveness of the photosensitive layer, improving coating property, improving property of injecting a charge from the support, or protecting the photosensitive layer from electrical breakdown.

The intermediate layer can be formed by using a material such as polyvinyl alcohol, poly-N-vinylimidazole, polyethylene oxide, ethylcellulose, an ethylene-acrylic acid copolymer, casein, polyamide, N-methoxymethylated nylon 6, copolymer nylon, an animal glue, or gelatin.

The thickness of the intermediate layer is preferably in the range of 0.1 to 2 μm.

Examples of the charge generating substance used for the electrophotographic photoreceptor of the present invention include: selenium-tellurium-based, pyririum-based, and thiapyririum-based dyes; phthalocyanine pigments having various central metals and various crystal systems (such as α, β, γ, ε, and X types); anthanthrone pigments; dibenzpyrenequinone pigments; pyranthrone pigments; azo pigments such as a monoazo pigment, a disazo pigment, and a trisazo pigment; indigo pigments; quinacridone pigments; asymmetrical quinocyanine pigments; quinocyanine pigments; and amorphous silicon (described in, for example, JP 54-143645 A). Each of those charge generating substances may be used alone, or two or more of them can be used.

In addition to the hole transporting compound having a chain-polymerizable functional group, examples of the charge transporting substance used for the electrophotographic photoreceptor of the present invention include: polymer compounds each having a heterocyclic ring or a condensed polycyclic aromatic group such as poly-N-vinylcarbazole and polystyryl anthracene; heterocyclic compounds such as pyrazoline, imidazole, oxazole, triazole, and carbazole; triarylalkane derivatives such as triphenylmethane; triarylalmine derivatives such as triphenylamine; phenylenediamine derivatives; N-phenylcarbazole derivatives; stilbene derivatives; and hydrazone derivatives.

When the photosensitive layer is subjected to function separation into the charge generating layer and the charge transporting layer, the charge generating layer can be formed by applying and drying an application liquid for a charge generating layer prepared by dispersing a charge generating substance together with a solvent and a binder resin. Examples of the dispersion method include methods using a homogenizer, an ultrasonic dispersing device, a ball mill, a vibrating ball mill, a sand mill, a roll mill, an at liter, a liquid-colliding high speed dispersing device, and the like. A ratio between the charge generating substance and the binder resin is preferably in the range of 1:0.3 to 1:4 (mass ratio). In addition, the charge generating substance alone can be subjected to film formation by means of a deposition method or the like to serve as the charge generating layer.

The thickness of the charge generating layer is preferably 5 μm or less, particularly preferably in the range of 0.1 to 2 μm.

When the photosensitive layer is subjected to function separation into the charge generating layer and the charge transporting layer, the charge transporting layer, especially the charge transporting layer which is not the surface layer of the electrophotographic photoreceptor, can be formed by applying and drying an application liquid for a charge transporting layer prepared by dissolving a charge transporting substance and a binder resin into a solvent. In addition, out of the above charge transporting substances, one itself having film forming property can be subjected to film formation alone without the use of a binder resin to serve as the charge transporting layer. A ratio between the charge transporting substance and the binder resin is preferably in the range of 2:8 to 10:0 (mass ratio), particularly preferably in the range of 3:7 to 10:0 (mass ratio). An excessively small amount of the charge transporting substance may reduce a charge transporting ability and cause a reduction in sensitivity or an increase in rest potential.

The thickness of the charge transporting layer, especially the charge transporting layer which is not the surface layer of the electrophotographic photoreceptor, is preferably in the range of 1 to 50 μm, more preferably in the range of 1 to 30 μm, still more preferably in the range of 3 to 30 μm, and particularly preferably in the range of 3 to 20 μm.

When a charge transporting substance and a charge generating substance are incorporated into the same layer, the layer can be formed by applying and drying an application liquid for the layer prepared by dispersing the charge generating substance and the charge transporting substance together with a binder resin and a solvent.

Examples of the binder resin used for the photosensitive layer (including the charge transporting layer and the charge generating layer) include: polymers or copolymers of vinyl compounds such as styrene, vinyl acetate, vinyl chloride, acrylic ester, methacrylic ester, vinylidene fluoride, and trifluoroethylene; polyvinyl alcohol resins; polyvinyl acetal resins; polyvinyl butyral resins; polycarbonate resins; polyarylate resins; polyester resins; polysulfone resins; polyphenylene oxide resins; polyurethane resins; cellulose resins; phenol resins; melamine resins; silicon resins; and epoxy resins. Each of them can be used alone, or two or more of them can be used as a mixture or a copolymer.

Next, the intermediate transfer body used in the present invention will be described in more detail.

A resin, which is a main material out of the materials for molding the intermediate transfer body, is preferably a thermoplastic resin from the viewpoint of moldability. However, the resin is not particularly limited as long as it is selected in such a manner that the universal hardness value (HU) and elastic deformation rate of the surface of the intermediate transfer body fall within the above ranges. Examples of the resin include: olefin resins such as polyethylene and polypropylene; polystyrene resins; acrylic resins; polyester resins; polycarbonate resins; sulfur-containing resins such as polysulfone, polyethersulfone, and polyphenylene sulfide; fluorine-containing resins such as polyvinylidene fluoride (PVDF), polyethylene-ethylene tetrafluoride copolymers (ETFE), and polytetrafluoroethylene (PTFE); polyurethane resins; silicone resins; ketone resins; polyvinylidene chloride; thermoplastic polyimide resins; polyamide resins; denatured polyphenylene oxide resins; and various denatured resins of them. Each of them can be used alone, or two or more of them can be used as a mixture or a copolymer.

To control the universal hardness value (HU) and elastic deformation rate of the surface of the intermediate transfer body, an elastic body such as rubber may be used alone, or a mixture of the elastic body with the above resins may be used. For example, a chloroprene rubber (CR rubber), a fluororubber, or a silicone rubber can be used.

In addition, a conducting agent can be used for adjusting an electrical resistance value of the intermediate transfer body. Examples of the conducting agent include: conductive fillers such as carbon black and conductive metal oxides; low-molecular-weight ion conducting agents such as metal salts and glycols; antistatic resins containing ether bonds, hydroxyl groups, and the like in their molecules; and organic polymer compounds exhibiting electron conductivity.

When the conducting agent is used, a state of dispersion of the resin and the conducting agent plays an important role. Materials and dispersing means must be appropriately selected so that neither the agglomeration of particles nor the extreme separation of part of the components occurs.

Appropriate selection of the materials such as those described above allows the universal hardness value (HU) and elastic deformation rate of the surface of the intermediate transfer body to be adjusted. Furthermore, a method of mixing inorganic fillers such as mica, kaolins, bentonite, acid clay, barium sulfate, zinc oxide, and other various whiskers is preferably used for adjusting the universal hardness value (HU) and elastic deformation rate of the surface of the intermediate transfer body. Each of them can be used alone, or two or more of them can be used as a mixture.

Examples of the shape of the intermediate transfer body include a cylindrical shape (drum shape) and a belt shape. However, the cylindrical shape is preferable.

Next, the electrophotographic apparatus of the present invention will be described in more detail.

The electrophotographic apparatus of the present invention is characterized by including: the electrophotographic photoreceptor with a surface having a specific universal hardness value (HU) and a specific elastic deformation rate; and the intermediate transfer body with a surface having a specific universal hardness value (HU) and a specific elastic deformation rate as described above.

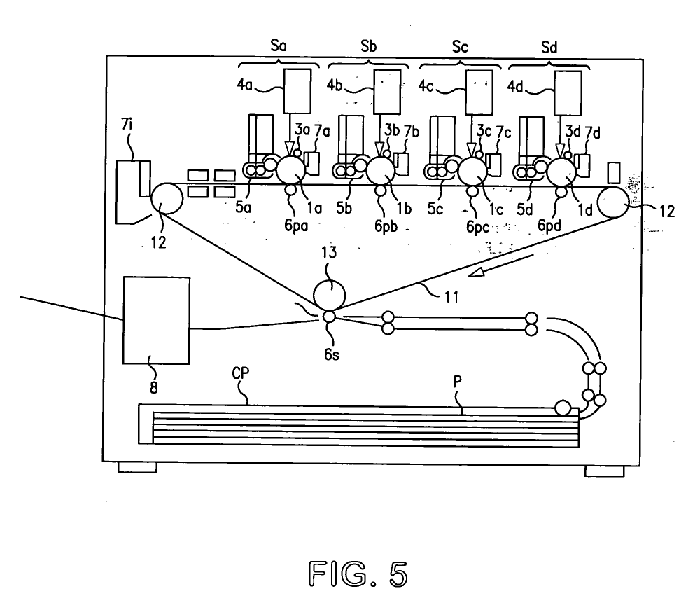

FIG. 5 is a schematic sectional drawing showing an example of the electrophotographic apparatus of the present invention.

The electrophotographic apparatus shown in FIG. 5 is a color electrophotographic apparatus that forms a color image by using 4 color (yellow, magenta, cyan, and black) toners. The apparatus includes a first image forming unit Sa, a second image forming unit Sb, a third image forming unit Sc, and a fourth image forming unit Sd.

The image forming units Sa to Sd have cylindrical (drum-shaped) electrophotographic photoreceptors (hereinafter, referred to as “photosensitive drums”) 1a, 1b, 1c, and 1d, and primary charging devices (charging means) 3a, 3b, 3c, and 3d, exposing devices (exposing means) 4a, 4b, 4c, and 4d, developing devices (developing means) 5a, 5b, 5c, and 5d, and cleaning devices (cleaning means) 7a, 7b, 7c, and 7d arranged on the peripheries of the photosensitive drums 1a to 1d, respectively. Each of the photosensitive drums 1a to 1d is rotated counterclockwise in the figure at a predetermined peripheral speed (process speed).

The surfaces of the photosensitive drums 1a to 1d are evenly charged with predetermined polarities and potentials by the primary charging devices 3a to 3d during rotation of the drums. Subsequently, the surfaces receive exposure light (image exposure light) from the exposing devices 4a to 4d (such as a color separation/image formation exposure optical system for a color original image and a scanning exposure system by means of a laser scanner that outputs a laser beam modulated in accordance with time sequence electrical digital pixel signals of image information). As a result, electrostatic latent images corresponding to respective color component images of an intended color image (a yellow component image, a magenta component image, a cyan component image, and a black component image) are formed on the surfaces of the photosensitive drums 1a to 1d.

Next, the electrostatic latent image on the surface of the photosensitive drum 1a is developed with a black toner by the developing device 5a (black developing device 5a). The yellow developing device 5b, the magenta developing device 5c, and the cyan developing device 5d are also actuated to form yellow, magenta, and cyan toner images on the surfaces of the photosensitive drums 1b to 1d.

A belt-shaped intermediate transfer body (hereinafter, referred to as “intermediate transfer belt”) 11 is brought into abutment with the photosensitive drums 1a to 1d with a predetermined pressing force by primary transfer rollers (primary transfer members) 6pa, 6pb, 6pc, and 6pd opposed to the photosensitive drums 1a to 1d, respectively. Then, the belt 11 is rotated clockwise in the figure at the same peripheral speed as that of each of the photosensitive drums 1a to 1d in association with the rotation of the photosensitive drums 1a to 1d and the primary transfer rollers 6pa to 6pd. Reference numeral 12 denotes a stretching roller that stretches the intermediate transfer belt 11 together with a secondary transfer opposing roller 13.

The black toner image formed on the surface of the photosensitive drum 1a is primarily transferred onto the surface of the intermediate transfer belt 11 by an electric field generated by a primary transfer bias applied from the primary transfer roller 6pa to the intermediate transfer belt 11 while the image passes through an abutting portion of the photosensitive drum 1a and the intermediate transfer belt 11.

Similarly, the yellow toner image, the magenta toner image, and the cyan toner image are sequentially transferred from the photosensitive drums 1b to 1d respectively onto the surface of the intermediate transfer belt 11 so as to overlap one another. Thus, a synthetic toner image corresponding to the intended color image is formed.

The primary transfer bias is opposite in polarity to the toners. When the polarity of each of the toners is negative, the primary transfer bias is preferably in the range of +100 V to 2 kV.

After the completion of the primary transfer, the surfaces of the photosensitive drums 1a to 1d are cleaned by the cleaning devices 7a to 7d.

A secondary transfer roller (secondary transfer member) 6s is supported with bearings in parallel with the secondary transfer opposing roller 13, and is placed to be in abutment with the intermediate transfer belt 11 from a lower face portion of the intermediate transfer belt 11.

A transfer material P is fed from a sheet feeding cassette CP at a predetermined timing to the abutting portion of the intermediate transfer belt 11 and the secondary transfer roller 6s through a transfer material guide. In addition, a secondary transfer bias is applied to the secondary transfer roller 6s. The secondary transfer bias causes the synthetic toner image to be secondarily transferred from the intermediate transfer belt 11 onto the transfer material P.

After the completion of the secondary transfer, the surface of the intermediate transfer belt 11 is cleaned by a cleaning device 7i for an intermediate transfer belt.

The transfer material P onto which the synthetic toner image was transferred is introduced into a fixing device 8, whereby the synthetic toner image is heated and fixed onto the transfer material P.

Hereinafter, the present invention will be described in more detail by way of specific examples. However, the present invention is not limited to these examples. The term “part” in examples indicates “part by mass”.

### PRODUCTION EXAMPLE 1 OF ELECTROPHOTOGRAPHIC PHOTORECEPTOR

An aluminum cylinder having a diameter of 84 mm and a length of 370 mm was subjected to a honing treatment and to ultrasonic cleaning. Thus, a support was prepared.

Next, 5 parts of N-methoxymethylated nylon 6 were dissolved into 95 parts of methanol to prepare an application liquid for an intermediate layer.

The application liquid for an intermediate layer was applied onto the support by means of a dip coating method, and was dried for 20 minutes at 100° C. to form an intermediate layer having a thickness of 0.6 μm.

Next, 3 parts of oxytitanium phthalocyanine crystal (charge generating substance) having strong peaks at Bragg angles 2θ±0.2° of 9.0°, 14.2°, 23.9°, and 27.1° in CuKα characteristic X-ray diffraction, 3 parts of a polyvinyl butyral resin (tradename: S-LEC BM2, manufactured by Sekisui Chemical Co., Ltd.), and 35 parts of cyclohexanone were dispersed for 2 hours in a sand mill device using glass beads each having a diameter of 1 mm. Then, 60 parts of ethyl acetate were added to the resultant to prepare an application liquid for a charge generating layer.

The application liquid for a charge generating layer was applied onto the intermediate layer by means of a dip coating method, and was dried for 10 minutes at 50° C. to form a charge generating layer having a thickness of 0.2 μm.

Next, 60 parts of a hole transporting compound having a structure represented by the following formula (E-1) were dissolved into a mixed solvent of 30 parts of monochlorobenzene/30 parts of dichloromethane to prepare an application liquid for a charge transporting layer.

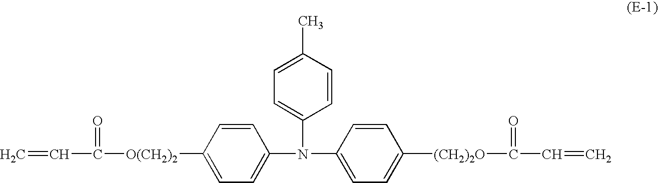

The application liquid for a charge transporting layer was applied onto the charge generating layer by means of a dip coating method.

Next, the application liquid for a charge transporting layer applied onto the charge generating layer was irradiated with an electron ray under an atmosphere having an oxygen concentration of 10 ppm at an acceleration voltage of 150 kV and an irradiation dose of 4 Mrad. After that, a heat treatment was carried out under the same atmosphere for 10 minutes under a condition that the temperature of an electrophotographic photoreceptor (=an object to be irradiated with the electron ray) was 100° C. Thus, a charge transporting layer having a thickness of 15 μm was formed.

Thus, an electrophotographic photoreceptor 1 which had the intermediate layer, the charge generating layer, and the charge transporting layer in this order on the support and in which the charge transporting layer was a surface layer was formed.

A total of seven electrophotographic photoreceptors 1 were prepared. One of them was used for measuring surface physical properties (the universal hardness value (HU) and the elastic deformation rate).

### PRODUCTION EXAMPLE 2 OF ELECTROPHOTOGRAPHIC PHOTORECEPTOR

An electrophotographic photoreceptor was prepared in the same manner as in the electrophotographic photoreceptor 1 except that the irradiation dose at the time of irradiation of the application liquid for a charge transporting layer with an electron ray was changed from 4 Mrad to 8 Mrad. The resultant electrophotographic photoreceptor was provided as an electrophotographic photoreceptor 2.

A total of two electrophotographic photoreceptors 2 were prepared. One of them was used for measuring the surface physical properties.

### PRODUCTION EXAMPLE 3 OF ELECTROPHOTOGRAPHIC PHOTORECEPTOR

An electrophotographic photoreceptor was prepared in the same manner as in the electrophotographic photoreceptor 1 except that the irradiation dose at the time of irradiation of the application liquid for a charge transporting layer with an electron ray was changed from 4 Mrad to 20 Mrad. The resultant electrophotographic photoreceptor was provided as an electrophotographic photoreceptor 3.

A total of two electrophotographic photoreceptors 3 were prepared. One of them was used for measuring the surface physical properties.

### PRODUCTION EXAMPLE 4 OF ELECTROPHOTOGRAPHIC PHOTORECEPTOR

An intermediate layer and a charge generating layer were formed on a support in the same manner as in the electrophotographic photoreceptor 1.

Next, 10 parts of a styryl compound having a structure represented by the following formula (E-2) and 10 parts of a polycarbonate resin (viscosity average molecular weight (Mv): 20,000) having a repeating structural unit represented by the following formula (E-3) were dissolved into a mixed solvent of 50 parts of monochlorobenzene/30 parts of dichloromethane to prepare an application liquid for a first charge transporting layer.

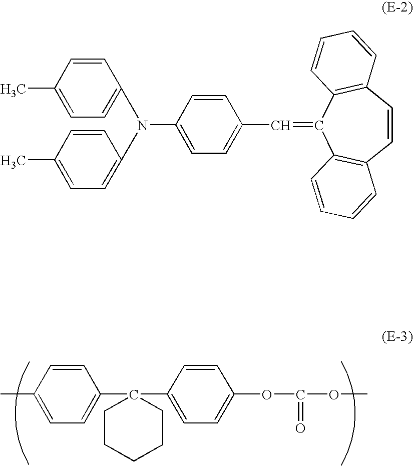

The application liquid for a first charge transporting layer was applied onto the charge generating layer by means of a dip coating method, and was dried for 1 hour at 120° C. to form a first charge transporting layer having a thickness of 20 μm.

Next, 60 parts of the hole transporting compound having the structure represented by the formula (E-1) were dissolved into a mixed solvent of 50 parts of monochlorobenzene/50 parts of dichloromethane to prepare an application liquid for a second charge transporting layer.

The application liquid for a second charge transporting layer was applied onto the first charge transporting layer by means of a spray coating method.

Next, the application liquid for a second charge transporting layer applied onto the first charge transporting layer was irradiated with an electron ray under an atmosphere having an oxygen concentration of 10 ppm at an acceleration voltage of 150 kV and an irradiation dose of 4 Mrad. After that, a heat treatment was carried out under the same atmosphere for 10 minutes under a condition that the temperature of an electrophotographic photoreceptor (=an object to be irradiated with the electron ray) was 100° C. Thus, a second charge transporting layer having a thickness of 5 μm was formed.

Thus, an electrophotographic photoreceptor 4 which had the intermediate layer, the charge generating layer, the first charge transporting layer, and the second charge transporting layer in this order on the support and in which the second charge transporting layer was a surface layer was formed.

A total of two electrophotographic photoreceptors 4 were prepared. One of them was used for measuring the surface physical properties.

### PRODUCTION EXAMPLE 5 OF ELECTROPHOTOGRAPHIC PHOTORECEPTOR

An electrophotographic photoreceptor was prepared in the same manner as in the electrophotographic photoreceptor 4 except that the irradiation dose at the time of irradiation of the application liquid for a second charge transporting layer with an electron ray was changed from 4M rad to 8M rad. The resultant electrophotographic photoreceptor was provided as an electrophotographic photoreceptor 5.

A total of two electrophotographic photoreceptors 5 were prepared. One of them was used for measuring the surface physical properties.

### PRODUCTION EXAMPLE 6 OF ELECTROPHOTOGRAPHIC PHOTORECEPTOR

An electrophotographic photoreceptor was prepared in the same manner as in the electrophotographic photoreceptor 4 except that the irradiation dose at the time of irradiation of the application liquid for a second charge transporting layer with an electron ray was changed from 4M rad to 20M rad. The resultant electrophotographic photoreceptor was provided as an electrophotographic photoreceptor 6.

A total of two electrophotographic photoreceptors 6 were prepared. One of them was used for measuring the surface physical properties.

### PRODUCTION EXAMPLE 7 OF ELECTROPHOTOGRAPHIC PHOTORECEPTOR

An electrophotographic photoreceptor was prepared in the same manner as in the electrophotographic photoreceptor 4 except that the hole transporting compound used for the second charge transporting layer was changed from the hole transporting compound having the structure represented by the formula (E-1) to a hole transporting compound having a structure represented by the following formula (E-4). The resultant electrophotographic photoreceptor was provided as an electrophotographic photoreceptor 7.

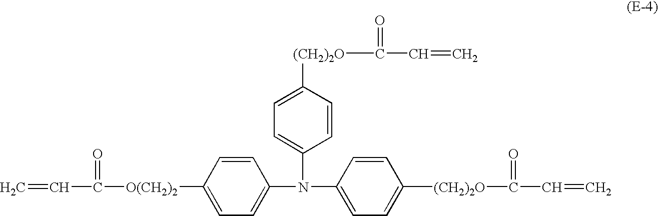

A total of two electrophotographic photoreceptors 7 were prepared. One of them was used for measuring the surface physical properties.

### PRODUCTION EXAMPLE 8 OF ELECTROPHOTOGRAPHIC PHOTORECEPTOR

An electrophotographic photoreceptor was prepared in the same manner as in the electrophotographic photoreceptor 5 except that the hole transporting compound used for the second charge transporting layer was changed from the hole transporting compound having the structure represented by the formula (E-1) to the hole transporting compound having the structure represented by the formula (E-4) The resultant electrophotographic photoreceptor was provided as an electrophotographic photoreceptor 8.

A total of two electrophotographic photoreceptors 8 were prepared. One of them was used for measuring the surface physical properties.

### PRODUCTION EXAMPLE 9 OF ELECTROPHOTOGRAPHIC PHOTORECEPTOR

An electrophotographic photoreceptor was prepared in the same manner as in the electrophotographic photoreceptor 6 except that the hole transporting compound used for the second charge transporting layer was changed from the hole transporting compound having the structure represented by the formula (E-1) to the hole transporting compound having the structure represented by the formula (E-4). The resultant electrophotographic photoreceptor was provided as an electrophotographic photoreceptor 9.

A total of two electrophotographic photoreceptors 9 were prepared. One of them was used for measuring the surface physical properties.

### PRODUCTION EXAMPLE 10 OF ELECTROPHOTOGRAPHIC PHOTORECEPTOR

An electrophotographic photoreceptor was prepared in the same manner as in the electrophotographic photoreceptor 1 except that the hole transporting compound used for the charge transporting layer was changed from the hole transporting compound having the structure represented by the formula (E-1) to a hole transporting compound having a structure represented by the following formula (E-5). The resultant electrophotographic photoreceptor was provided as an electrophotographic photoreceptor 10.

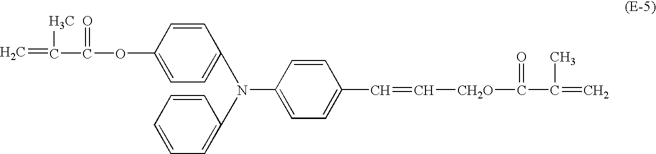

A total of two electrophotographic photoreceptors 10 were prepared. One of them was used for measuring the surface physical properties.

### PRODUCTION EXAMPLE 11 OF ELECTROPHOTOGRAPHIC PHOTORECEPTOR

An electrophotographic photoreceptor was prepared in the same manner as in the electrophotographic photoreceptor 1 except that the hole transporting compound used for the charge transporting layer was changed from the hole transporting compound having the structure represented by the formula (E-1) to a hole transporting compound having a structure represented by the following formula (E-6). The resultant electrophotographic photoreceptor was provided as an electrophotographic photoreceptor 11.

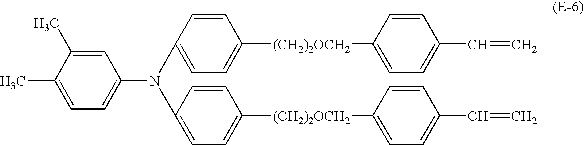

A total of two electrophotographic photoreceptors 11 were prepared. One of them was used for measuring the surface physical properties.

### PRODUCTION EXAMPLE 12 OF ELECTROPHOTOGRAPHIC PHOTORECEPTOR

An electrophotographic photoreceptor was prepared in the same manner as in the electrophotographic photoreceptor 1 except that the hole transporting compound used for the charge transporting layer was changed from the hole transporting compound having the structure represented by the formula (E-1) to a hole transporting compound having a structure represented by the following formula (E-7). The resultant electrophotographic photoreceptor was provided as an electrophotographic photoreceptor 12.

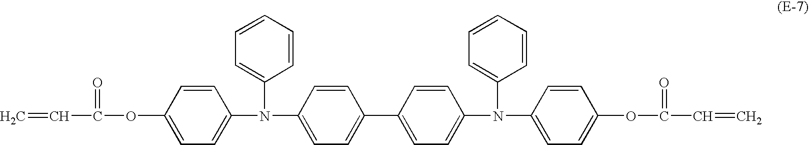

A total of two electrophotographic photoreceptors 12 were prepared. One of them was used for measuring the surface physical properties.

### PRODUCTION EXAMPLE 13 OF ELECTROPHOTOGRAPHIC PHOTORECEPTOR

An electrophotographic photoreceptor was prepared in the same manner as in the electrophotographic photoreceptor 7 except that the application liquid for a second charge transporting layer was changed to one prepared according to the following procedure. The resultant electrophotographic photoreceptor was provided as an electrophotographic photoreceptor 13.

That is, 40 parts of the hole transporting compound having the structure represented by the formula (E-4) and 20 parts of a hole transporting compound having a structure represented by the following formula (E-8) were dissolved into a mixed solvent of 50 parts of monochlorobenzene/50 parts of dichloromethane to prepare an application liquid for a second charge transporting layer of the electrophotographic photoreceptor 13.

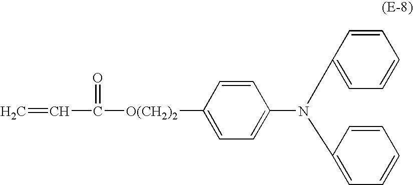

A total of two electrophotographic photoreceptors 13 were prepared. One of them was used for measuring the surface physical properties.

### PRODUCTION EXAMPLE 14 OF ELECTROPHOTOGRAPHIC PHOTORECEPTOR

An electrophotographic photoreceptor was prepared in the same manner as in the electrophotographic photoreceptor 1 except that the application liquid for a charge transporting layer was changed to one prepared according to the following procedure. The resultant electrophotographic photoreceptor was provided as an electrophotographic photoreceptor 14.

That is, first, 5 parts of polytetrafluoroethylene resin particles (tradename: LUBREOL-2, manufactured by Daikin Industries, Ltd.) and 50 parts of monochlorobenzene were dispersed in a sand mill device using glass beads. Then, 60 parts of the hole transporting compound having the structure represented by the formula (E-1) and 50 parts of dichloromethane were added to the resultant to dissolve the hole transporting compound having the structure represented by the formula (E-1). After that, 30 parts of dichloromethane were added to the resultant to prepare an application liquid for a charge transporting layer of the electrophotographic photoreceptor 14.

A total of two electrophotographic photoreceptors 14 were prepared. One of them was used for measuring the surface physical properties.

### COMPARATIVE PRODUCTION EXAMPLE 1 OF ELECTROPHOTOGRAPHIC PHOTORECEPTOR

An electrophotographic photoreceptor was prepared in the same manner as in the electrophotographic photoreceptor 1 except that the heat treatment after the irradiation of the application liquid for a charge transporting layer with an electron ray was not carried out. The resultant electrophotographic photoreceptor was provided as an electrophotographic photoreceptor C1.

A total of two electrophotographic photoreceptors C1 were prepared. One of them was used for measuring the surface physical properties.

### COMPARATIVE PRODUCTION EXAMPLE 2 OF ELECTROPHOTOGRAPHIC PHOTORECEPTOR

An electrophotographic photoreceptor was prepared in the same manner as in the electrophotographic photoreceptor 2 except that the heat treatment after the irradiation of the application liquid for a charge transporting layer with an electron ray was not carried out. The resultant electrophotographic photoreceptor was provided as an electrophotographic photoreceptor C2.

A total of two electrophotographic photoreceptors C2 were prepared. One of them was used for measuring the surface physical properties.

### COMPARATIVE PRODUCTION EXAMPLE 3 OF ELECTROPHOTOGRAPHIC PHOTORECEPTOR

An electrophotographic photoreceptor was prepared in the same manner as in the electrophotographic photoreceptor 9 except that the heat treatment after the irradiation of the application liquid for a second charge transporting layer with an electron ray was not carried out. The resultant electrophotographic photoreceptor was provided as an electrophotographic photoreceptor C3.

A total of two electrophotographic photoreceptors C3 were prepared. One of them was used for measuring the surface physical properties.

### COMPARATIVE PRODUCTION EXAMPLE 4 OF ELECTROPHOTOGRAPHIC PHOTORECEPTOR

An intermediate layer and a charge generating layer were formed on a support in the same manner as in the electrophotographic photoreceptor 1.

Next, 10 parts of the styryl compound having the structure represented by the formula (E-2) and 10 parts of the polycarbonate resin (viscosity average molecular weight (Mv): 20,000) having the repeating structural unit represented by the formula (E-3) were dissolved into a mixed solvent of 50 parts of monochlorobenzene/30 parts of dichloromethane to prepare an application liquid for a charge transporting layer.

The application liquid for a charge transporting layer was applied onto the charge generating layer by means of a dip coating method, and was dried for 1 hour at 120° C. to form a charge transporting layer having a thickness of 30 μm.

Thus, an electrophotographic photoreceptor C4 which had the intermediate layer, the charge generating layer, and the charge transporting layer in this order on the support and in which the charge transporting layer was a surface layer was formed.

A total of two electrophotographic photoreceptors C4 were prepared. One of them was used for measuring the surface physical properties.

### COMPARATIVE PRODUCTION EXAMPLE 5 OF ELECTROPHOTOGRAPHIC PHOTORECEPTOR

An intermediate layer, a charge generating layer, and a charge transporting layer were formed on a support in the same manner as in the electrophotographic photoreceptor 1.

Next, a solution containing 100 parts of antimony-containing tin oxide fine particles having an average particle size of 0.02 μm (tradename: T-1, manufactured by Mitsubishi Materials Corporation), 30 parts of (3,3,3-trifluoropropyl)trimethoxysilane (manufactured by Shin-Etsu Chemical Co., Ltd.), and 300 parts of a solution of 95% ethanol-5% water was dispersed for 1 hour in a milling device. The solution after the dispersion was filtered, washed with ethanol, dried, and then heated at 120° C. for 1 hour to treat the surfaces of the antimony-containing tin oxide fine particles.

Next, 25 parts of a curing acrylic monomer (photopolymerizable monomer) having a structure represented by the following formula (E-10), 5 parts of 2,2-dimethoxy-2-phenylacetophenone (photopolymerization initiator), 50 parts of the antimony-containing tin oxide fine particles after the surface treatment, and 300 parts of ethanol were dispersed for 96 hours in a sand mill device. After that, 20 parts of polytetrafluoroethylene resin particles (tradename: LUBREON L-2, manufactured by Daikin Industries, Ltd.) were added to the resultant, and the whole was dispersed for an additional 8 hours in the sand mill device to prepare an application liquid for a protective layer.

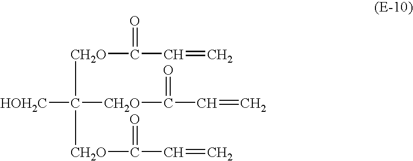

The application liquid for a protective layer was applied onto the charge transporting layer by means of a dip coating method, and was dried for 10 minutes at 50° C. After that, the liquid was irradiated with ultraviolet light having a light intensity of 1,000 mW/cm² by a metal halide lamp for 30 seconds to form a protective layer having a thickness of 3 μm.

Thus, an electrophotographic photoreceptor C5 which had the intermediate layer, the charge generating layer, the charge transporting layer, and the protective layer in this order on the support and in which the protective layer was a surface layer was formed.

### COMPARATIVE PRODUCTION EXAMPLE 6 OF ELECTROPHOTOGRAPHIC PHOTORECEPTOR

An intermediate layer, a charge generating layer, and a first charge transporting layer were formed on a support in the same manner as in the electrophotographic photoreceptor 4.

Next, 10 parts of the polycarbonate resin (viscosity average molecular weight (Mv): 20,000) having the repeating structural unit represented by the formula (E-3) were dissolved into a mixed solvent of 100 parts of monochlorobenzene/60 parts of dichloromethane. Then, 1 part of hydrophobic silica particles was mixed with and dispersed into the resultant solution to prepare an application liquid for a protective layer.

The application liquid for a protective layer was applied onto the first charge transporting layer by means of a spray coating method, and was dried for 60 minutes at 110° C. to form a protective layer having a thickness of 1.0 μm.

Thus, an electrophotographic photoreceptor C6 which had the intermediate layer, the charge generating layer, the first charge transporting layer (charge transporting layer), and the protective layer in this order on the support and in which the protective layer was a surface layer was formed.

A total of two electrophotographic photoreceptors C6 were prepared. One of them was used for measuring the surface physical properties.

### COMPARATIVE PRODUCTION EXAMPLE 7 OF ELECTROPHOTOGRAPHIC PHOTORECEPTOR

An intermediate layer, a charge generating layer, and a first charge transporting layer were formed on a support in the same manner as in the electrophotographic photoreceptor 6.

Next, 30 parts of the hole transporting compound having the structure represented by the formula (E-1) and 10 parts of a compound having a structure represented by the following formula (E-11) were dissolved into a mixed solvent of 50 parts of monochlorobenzene/50 parts of dichloromethane to prepare an application liquid for a second charge transporting layer.

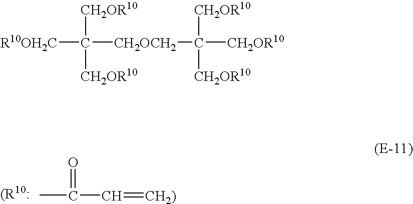

The application liquid for a second charge transporting layer was applied onto the first charge transporting layer by means of a spray coating method.

Next, the application liquid for a second charge transporting layer applied onto the first charge transporting layer was irradiated with an electron ray under an atmosphere having an oxygen concentration of 10 ppm at an acceleration voltage of 150 kV and an irradiation dose of 20 Mrad. After that, a heat treatment was carried out under the same atmosphere for 10 minutes under a condition that the temperature of an electrophotographic photoreceptor (=an object to be irradiated with the electron ray) was 100° C. Thus, a second charge transporting layer having a thickness of 2 μm was formed.

Thus, an electrophotographic photoreceptor C7 which had the intermediate layer, the charge generating layer, the first charge transporting layer, and the second charge transporting layer in this order on the support and in which the second charge transporting layer was a surface layer was formed.

A total of two electrophotographic photoreceptors C7 were prepared. One of them was used for measuring the surface physical properties.

(Measurement of Surface Physical Properties of Electrophotographic Photoreceptors)

Each of the electrophotographic photoreceptors 1 to 14 and C1 to C7 for measuring the surface physical properties was left under a 25° C./50% RH environment for 24 hours. After that, the universal hardness value (HU) and elastic deformation rate of the surface of each of the electrophotographic photoreceptors were measured as described above. Table 1 shows the measurements.

TABLE 1

| | | Elastic deformation |
|---|---|---|
| | HU | rate |
| | (N/mm²) | (%) |
| Electrophotographic photoreceptor 1 | 190 | 52 |
| Electrophotographic photoreceptor 2 | 193 | 53 |
| Electrophotographic photoreceptor 3 | 195 | 55 |
| Electrophotographic photoreceptor 4 | 176 | 53 |
| Electrophotographic photoreceptor 5 | 180 | 55 |
| Electrophotographic photoreceptor 6 | 183 | 56 |
| Electrophotographic photoreceptor 7 | 206 | 53 |
| Electrophotographic photoreceptor 8 | 208 | 57 |
| Electrophotographic photoreceptor 9 | 215 | 60 |
| Electrophotographic photoreceptor 10 | 210 | 52 |
| Electrophotographic photoreceptor 11 | 215 | 51 |
| Electrophotographic photoreceptor 12 | 207 | 55 |
| Electrophotographic photoreceptor 13 | 210 | 52 |
| Electrophotographic photoreceptor 14 | 174 | 51 |
| Electrophotographic photoreceptor C1 | 140 | 55 |
| Electrophotographic photoreceptor C2 | 201 | 45 |
| Electrophotographic photoreceptor C3 | 240 | 57 |
| Electrophotographic photoreceptor C4 | 216 | 40 |
| Electrophotographic photoreceptor C5 | 331 | 42 |
| Electrophotographic photoreceptor C6 | 237 | 38 |
| Electrophotographic photoreceptor C7 | 250 | 68 |

### PRODUCTION EXAMPLES 1 TO 3 AND COMPARATIVE PRODUCTION EXAMPLES C1 AND C2 OF INTERMEDIATE TRANSFER BELT

Intermediate transfer belts each having a three-layer configuration consisting of a base layer (lower layer), an intermediate layer, and a surface layer (upper layer) or a monolayer configuration were prepared by using the materials shown in Table 2. An intermediate transfer belt of Production Example 1 was defined as an intermediate transfer belt 1, an intermediate transfer belt of Production Example 2 was defined as an intermediate transfer belt 2, an intermediate transfer belt of Production Example 3 was defined as an intermediate transfer belt 3, an intermediate transfer belt of Comparative Production Example 1 was defined as an intermediate transfer belt C1, and an intermediate transfer belt of Comparative Production Example 2 was defined as an intermediate transfer belt C2.

A total of two intermediate transfer belts 1 were prepared (the same holds true for the intermediate transfer belts 2, C1, and C2). One of them was used for measuring the surface physical properties (the same holds true for the intermediate transfer belts 2, C1, and C2). In addition, a total of 23 intermediate transfer belts 3 were prepared. One of them was used for measuring the surface physical properties.

TABLE 2

| | Base layer | Intermediate layer | Surface layer |
|---|---|---|---|
| Production | PVDF | CR rubber | Fluororubber |
| Example 1 of | | JISA hardness: 65° | |
| intermediate | | | |
| transfer belt | | | |
| Intermediate | | | |
| transfer belt 1 | | | |
| Production | PVDF | CR rubber | PTFE particles |
| Example 2 of | | JISA hardness: 70° | dispersed into |
| intermediate | | | fluororubber |
| transfer belt | | | |
| Intermediate | | | |
| transfer belt 2 | | | |
| Production | PVDF | CR rubber | Fluororubber |
| Example 3 of | | JISA hardness: 70° | |
| intermediate | | | |
| transfer belt | | | |
| Intermediate | | | |
| transfer belt 3 | | | |
| Comparative | PVDF | CR rubber | DeSolite coat |
| Production | | JISA hardness: 70° | (photopolymerizable |
| Example 1 of | | | resin) |
| intermediate | | | |
| transfer belt | | | |
| Intermediate | | | |
| transfer belt C1 | | | |
| Comparative | Polyimide resin (monolayer) | | |
| Production | | | |
| Example 2 of | | | |
| intermediate | | | |
| transfer belt | | | |
| Intermediate | | | |
| transfer belt C2 | | | |

Carbon black was dispersed as a conducting agent into the base layers and intermediate layers of the intermediate transfer belts 1 to 3 and the base layers, intermediate layers, and surface layers of the intermediate transfer belts C1 and C2.

(Measurement of Surface Physical Properties of Intermediate Transfer Belt)

Each of the intermediate transfer belts 1 to 3 and C1 and C2 for measuring the surface physical properties was left under a 25° C./50% RH environment for 24 hours. After that, the universal hardness value (HU) and elastic deformation rate of the surface of each of the intermediate transfer belts were measured as described above. Table 3 shows the measurements.

TABLE 3

| | | Elastic |
|---|---|---|
| | HU | deformation rate |
| | (N/mm²) | (%) |
| Intermediate | 14 | 62 |
| transfer belt 1 | | |
| Intermediate | 31 | 77 |
| transfer belt 2 | | |
| Intermediate | 60 | 58 |
| transfer belt 3 | | |
| Intermediate | 65 | 40 |
| transfer belt C1 | | |
| Intermediate | 273 | 35 |
| transfer belt C2 | | |

### EXAMPLE 1-1

The electrophotographic photoreceptor 1 and the intermediate transfer belt 1 were placed in the electrophotographic apparatus having a configuration shown in FIG. 5, and a 100,000-sheet-feeding endurance test was performed under a normal-temperature and normal-humidity (23° C., 50% RH) environment. Image quality (transferability at a flaw portion <the characteristic flaw portion described above> on the surface of the electrophotographic photoreceptor) and durability (at a position corresponding to the characteristic flaw portion on the surface of the electrophotographic photoreceptor) after the endurance test were evaluated. A halftone image and a solid image were used for evaluating the image quality. The level of development of white and black streaks on the images was evaluated. Table 4 shows the results of the evaluation.

### EXAMPLE 1-2

Evaluation was performed in the same manner as in Example 1-1 except that the intermediate transfer belt 1 was changed to the intermediate transfer belt 2 Table 4 shows the results of the evaluation.

### EXAMPLE 1-3

Evaluation was performed in the same manner as in Example 1-1 except that the intermediate transfer belt 1 was changed to the intermediate transfer belt 3. Table 4 shows the results of the evaluation.

### COMPARATIVE EXAMPLE 1-1

Evaluation was performed in the same manner as in Example 1-1 except that the intermediate transfer belt 1 was changed to the intermediate transfer belt C1. Table 4 shows the results of the evaluation.

### COMPARATIVE EXAMPLE 1-2

Evaluation was performed in the same manner as in Example 1-1 except that the intermediate transfer belt 1 was changed to the intermediate transfer belt C2. Table 4 shows the results of the evaluation.

TABLE 4

| | Electro- | Intermediate | | |
|---|---|---|---|---|
| | photographic | transfer | Image | |
| | photoreceptor | belt | quality | Durability |
| Example | 1 | 1 | Good | Good |
| 1-1 | | | | |
| Example | 1 | 2 | Good | Good |
| 1-2 | | | | |
| Example | 1 | 3 | Good | Good |
| 1-3 | | | | |
| Comparative | 1 | C1 | Good | Cracks |
| Example | | | | developed on |
| 1-1 | | | | the surface |
| | | | | of the |
| | | | | intermediate |
| | | | | transfer belt |
| Comparative | 1 | C2 | Insufficient | Good |
| Example | | | transfer | |
| 1-2 | | | | |

The results of Examples 1-1 to 1-3 and Comparative Examples 1-1 and 1-2 show the following.

The case where the universal hardness value (HU) of the intermediate transfer body (intermediate transfer belt) is smaller than the universal hardness value (HU) of the surface of the electrophotographic photoreceptor is advantageous for the image quality, that is, the transferability at the characteristic flaw portion on the surface of the electrophotographic photoreceptor.

In addition, the durability of the intermediate transfer body (intermediate transfer belt) depends on the elastic deformation rate. Each of the intermediate transfer belt 3 of Example 1-3 and the intermediate transfer belt C1 of Comparative Example 1-1 had a universal hardness value (HU) of approximately 60 N/mm². However, cracks developed on the surface of the intermediate transfer belt C1. There was a large difference in elastic deformation rate between the belts. A large elastic deformation rate, specifically an elastic deformation rate of 50% or more is advantageous. Furthermore, both of the intermediate transfer belt 1 of Example 1-1 and the intermediate transfer belt 2 of Example 1-2 had good durability in spite of their low universal hardness values. This is partly attributed to the fact that both the belts had large elastic deformation rates.

### EXAMPLE 2-1

The electrophotographic photoreceptor 1 and the intermediate transfer belt 3 were placed in the electrophotographic apparatus having the configuration shown in FIG. 5, and a 100,000-sheet-feeding endurance test was performed under a normal-temperature and normal-humidity (23° C., 50% RH) environment. Evaluation of an output image during the endurance test and measurement of an amount of shaving on the surface of the electrophotographic photoreceptor after the endurance test were performed. An eddy-current instrument for measuring thickness PERMASCOPE TYPE E111 manufactured by Fischer was used for measuring the amount of shaving. In addition, after the sheet-feeding endurance test, the shape of a flaw formed on the surface of the electrophotographic photoreceptor was measured by using a two-dimensional contact surface roughness tester (tradename: CONTACT SURFACE ROUGHNESS MEASURING INSTRUMENT SURFCORDER SE3500, manufactured by Kosaka Laboratory Ltd.). Table 5 shows the results of the evaluation and the measurement.

### EXAMPLE 2-2

Evaluation was performed in the same manner as in Example 2-1 except that the electrophotographic photoreceptor 1 was changed to the electrophotographic photoreceptor 2. Table 5 shows the results of the evaluation and the measurement.

### EXAMPLE 2-3

Evaluation was performed in the same manner as in Example 2-1 except that the electrophotographic photoreceptor 1 was changed to the electrophotographic photoreceptor 3. Table 5 shows the results of the evaluation and the measurement.

### EXAMPLE 2-4

Evaluation was performed in the same manner as in Example 2-1 except that the electrophotographic photoreceptor 1 was changed to the electrophotographic photoreceptor 4. Table 5 shows the results of the evaluation and the measurement.

### EXAMPLE 2-5

Evaluation was performed in the same manner as in Example 2-1 except that the electrophotographic photoreceptor 1 was changed to the electrophotographic photoreceptor 5. Table 5 shows the results of the evaluation and the measurement.

### EXAMPLE 2-6

Evaluation was performed in the same manner as in Example 2-1 except that the electrophotographic photoreceptor 1 was changed to the electrophotographic photoreceptor 6. Table 5 shows the results of the evaluation and the measurement.

### EXAMPLE 2-7

Evaluation was performed in the same manner as in Example 2-1 except that the electrophotographic photoreceptor 1 was changed to the electrophotographic photoreceptor 7. Table 5 shows the results of the evaluation and the measurement.

### EXAMPLE 2-8

Evaluation was performed in the same manner as in Example 2-1 except that the electrophotographic photoreceptor 1 was changed to the electrophotographic photoreceptor 8. Table 5 shows the results of the evaluation and the measurement.

### EXAMPLE 2-9

Evaluation was performed in the same manner as in Example 2-1 except that the electrophotographic photoreceptor 1 was changed to the electrophotographic photoreceptor 9. Table 5 shows the results of the evaluation and the measurement.

### EXAMPLE 2-10

Evaluation was performed in the same manner as in Example 2-1 except that the electrophotographic photoreceptor 1 was changed to the electrophotographic photoreceptor 10. Table 5 shows the results of the evaluation and the measurement.

### EXAMPLE 2-11

Evaluation was performed in the same manner as in Example 2-1 except that the electrophotographic photoreceptor 1 was changed to the electrophotographic photoreceptor 11. Table 5 shows the results of the evaluation and the measurement.

### EXAMPLE 2-12

Evaluation was performed in the same manner as in Example 2-1 except that the electrophotographic photoreceptor 1 was changed to the electrophotographic photoreceptor 12. Table 5 shows the results of the evaluation and the measurement.

### EXAMPLE 2-13

Evaluation was performed in the same manner as in Example 2-1 except that the electrophotographic photoreceptor 1 was changed to the electrophotographic photoreceptor 13. Table 5 shows the results of the evaluation and the measurement.

### EXAMPLE 2-14

Evaluation was performed in the same manner as in Example 2-1 except that the electrophotographic photoreceptor 1 was changed to the electrophotographic photoreceptor 14. Table 5 shows the results of the evaluation and the measurement.

### COMPARATIVE EXAMPLE 2-1

Evaluation was performed in the same manner as in Example 2-1 except that the electrophotographic photoreceptor 1 was changed to the electrophotographic photoreceptor C1. Table 6 shows the results of the evaluation and the measurement.

### COMPARATIVE EXAMPLE 2-2

Evaluation was performed in the same manner as in Example 2-1 except that the electrophotographic photoreceptor 1 was changed to the electrophotographic photoreceptor C2. Table 6 shows the results of the evaluation and the measurement.

### COMPARATIVE EXAMPLE 2-3

Evaluation was performed in the same manner as in Example 2-1 except that the electrophotographic photoreceptor 1 was changed to the electrophotographic photoreceptor C3. Table 6 shows the results of the evaluation and the measurement.

### COMPARATIVE EXAMPLE 2-4

Evaluation was performed in the same manner as in Example 2-1 except that the electrophotographic photoreceptor 1 was changed to the electrophotographic photoreceptor C4. Table 6 shows the results of the evaluation and the measurement.

### COMPARATIVE EXAMPLE 2-5

Evaluation was performed in the same manner as in Example 2-1 except that the electrophotographic photoreceptor 1 was changed to the electrophotographic photoreceptor C5. Table 6 shows the results of the evaluation and the measurement.

### COMPARATIVE EXAMPLE 2-6

Evaluation was performed in the same manner as in Example 2-1 except that the electrophotographic photoreceptor 1 was changed to the electrophotographic photoreceptor C6. Table 6 shows the results of the evaluation and the measurement.

### COMPARATIVE EXAMPLE 2-7

Evaluation was performed in the same manner as in Example 2-1 except that the electrophotographic photoreceptor 1 was changed to the electrophotographic photoreceptor C7. Table 6 shows the results of the evaluation and the measurement.

TABLE 5

| | | | | Amount of | |
|---|---|---|---|---|---|
| | Electrophotographic | Intermediate | Image quality | shaving | |
| | photoreceptor | transfer belt | evaluation | (μm) | |
| Example | 1 | 3 | Good | 1.2 | Width 10-20 μm |
| 2-1 | | | | | Depth 1-2 μm |
| Example | 2 | 3 | Good | 1.0 | Width 10-20 μm |
| 2-2 | | | | | Depth 1-2 μm |
| Example | 3 | 3 | Good | 1.0 | Width 10-20 μm |
| 2-3 | | | | | Depth 1-2 μm |
| Example | 4 | 3 | Good | 1.3 | Width 10-20 μm |
| 2-4 | | | | | Depth 1-2 μm |
| Example | 5 | 3 | Good | 1.7 | Width 20-40 μm |
| 2-5 | | | | | Depth 1-2 μm |
| Example | 6 | 3 | Good | 1.2 | Width 10-20 μm |
| 2-6 | | | | | Depth 1-2 μm |
| Example | 7 | 3 | Good | 0.9 | Width 10-20 μm |
| 2-7 | | | | | Depth 1-2 μm |
| Example | 8 | 3 | Good | 0.7 | Width 10-20 μm |
| 2-8 | | | | | Depth 1-2 μm |
| Example | 9 | 3 | Good | 0.6 | Width 10-20 μm |
| 2-9 | | | | | Depth 1-2 μm |
| Example | 10 | 3 | Good | 1.4 | Width 20-30 μm |
| 2-10 | | | | | Depth 1-2 μm |
| Example | 11 | 3 | Good | 1.8 | Width 20-40 μm |
| 2-11 | | | | | Depth 1-2 μm |
| Example | 12 | 3 | Good | 1.5 | Width 20-40 μm |
| 2-12 | | | | | Depth 1-2 μm |
| Example | 13 | 3 | Good | 1.0 | Width 10-20 μm |
| 2-13 | | | | | Depth 1-2 μm |
| Example | 14 | 3 | Good | 1.1 | Width 10-20 μm |
| 2-14 | | | | | Depth 1-2 μm |

TABLE 6

| | | | | Amount of | |
|---|---|---|---|---|---|
| | Electrophotographic | Intermediate | Image quality | shaving | |
| | photoreceptor | transfer belt | evaluation | (μm) | |
| Comparative | C1 | 3 | Streaks due to flaw | 4.5 | Width 100-300 μm |
| Example | | | | | Depth 2-4 μm |
| 2-1 | | | | | |
| Comparative | C2 | 3 | Streaks due to flaw | 2.3 | Width 100-300 μm |
| Example | | | | | Depth 2-4 μm |
| 2-2 | | | | | |
| Comparative | C3 | 3 | Streaks due to flaw | 0.8 | Width 100-200 μm |
| Example | | | | | Depth 2-4 μm |
| 2-3 | | | | | |
| Comparative | C4 | 3 | Streaks due to flaw | 25 | Width 100-300 μm |
| Example | | | and | (Complete | Depth 2-6 μm |
| 2-4 | | | development of fog | in a | |
| | | | | midpoint) | |
| Comparative | C5 | 3 | Streaks due to flaw | 8 | Width 100-300 μm |
| Example | | | | | Depth 2-5 μm |
| 2-5 | | | | | |
| Comparative | C6 | 3 | Streaks due to flaw | | |
| Example | | | | | |
| 2-6 | | | | | |
| Comparative | C7 | 3 | Streaks due to flaw | 1.5 | Width 100-200 μm |
| Example | | | | | Depth 2-3 μm |
| 2-7 | | | | | |

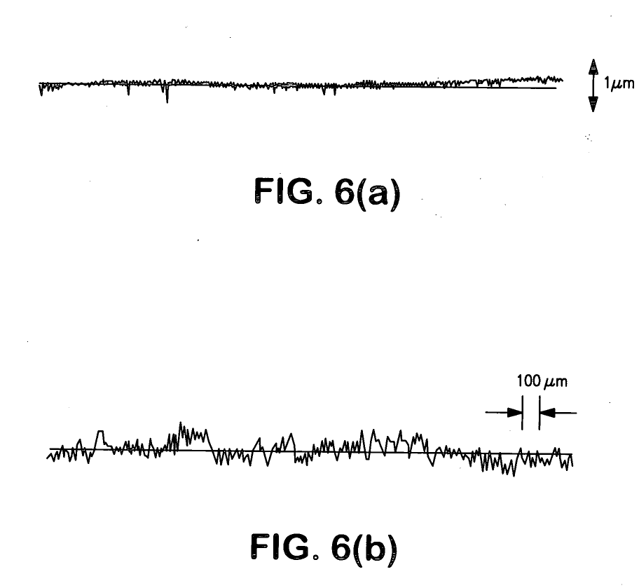

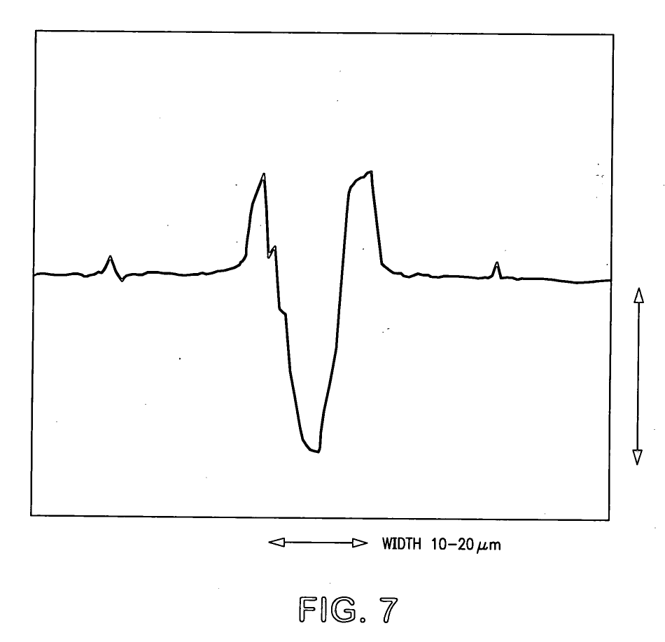

FIG. 6(a) and FIG. 7 show data on the shape of the flaw formed on the surface of the electrophotographic photoreceptor 1 of Example 2-1 after the sheet-feeding endurance test measured by using the two-dimensional contact surface roughness tester. As shown in FIG. 6(a) and FIG. 7, the flaw formed on the surface of the electrophotographic photoreceptor 1 after the sheet-feeding endurance test was of a sharp shape.

In addition, the shapes of the flaws formed on the surfaces of the electrophotographic photoreceptors 2 to 14 of Examples 2-2 to 2-14 were similar to that of the flaw formed on the surface of the electrophotographic photoreceptor 1 of Example 2-1.

In addition, after the sheet-feeding endurance test, the surface of the intermediate transfer belt 3 of each of Examples 2-1 to 2-14 showed nearly no flaw and nearly nor wear, and had good durability. Followability to the surface of the electrophotographic photoreceptor was also good.

FIG. 6(b) shows data on the shape of a flaw formed on the surface of the electrophotographic photoreceptor C1 of Comparative Example 2-1 after the sheet-feeding endurance test measured by using the two-dimensional contact surface roughness tester. As shown in FIG. 6(b), the flaw formed on the surface of the electrophotographic photoreceptor C1 after the sheet-feeding endurance test was of a gentle shape.

As is apparent from the above results, even though the elastic deformation rate was 48% or more and 65% or less, the electrophotographic photoreceptor C1 having a universal hardness value (HU) of less than 150 N/mm² showed an extremely large amount of shaving, and the electrophotographic photoreceptor C3 having a universal hardness value (HU) in excess of 220 N/mm² showed a small amount of shaving but involved the development of a flaw.

In addition, even though the universal hardness value (HU) was 150 N/mm² or more and 220 N/mm² or less, the electrophotographic photoreceptor C2 having an elastic deformation rate of less than 48% was poor in wear resistance, and involved the development of a deep flaw.

In addition, each of the electrophotographic photoreceptors C5, C6, and C7 each having a universal hardness value (HU) and an elastic deformation rate out of the above ranges had a problem associated with at least one of wear and a flaw, and was unable to form a good image.

In contrast, each of the electrophotographic photoreceptors 1 to 14 each having a universal hardness value (HU) of 150 N/mm² or more to 220 N/mm² or less, and an elastic deformation rate of 48% or more to 65% or less showed a small amount of shaving, and did not involve the development of a deep flaw. However, the electrophotographic photoreceptors involved the development of sharp and fine flaws. In each electrophotographic photoreceptor, when the universal hardness value (HU) and elastic deformation rate of the surface of the intermediate transfer body (intermediate transfer belt) were set to 220 N/mm² or less and 50% or more, respectively, and the universal hardness value (HU) of the surface of the intermediate transfer body (intermediate transfer belt) was set to be smaller than the universal hardness value (HU) of the surface of the electrophotographic photoreceptor, sufficient transferability and sufficient durability of the intermediate transfer body (intermediate transfer belt) were able to be obtained for the sharp and fine flaws.

As described above, according to the present invention, there can be provided an electrophotographic apparatus in which, even when the above characteristic flaw (flaw having a shape shown in FIG. 8(a)) suddenly develops on the surface of an electrophotographic photoreceptor, the above detrimental effects due to the flaw are suppressed, so good images can be formed continuously.

This application claims the right of priority under 35 U.S.C. §119 based on Japanese Patent Application No. JP 2004-027072 filed Feb. 3, 2004 and No. JP 2005-013967 filed Jan. 21, 2005 which are hereby incorporated by reference herein in their entirety as if fully set forth herein.

1. An electrophotographic apparatus, comprising:
an electrophotographic photoreceptor having a support and a photosensitive layer arranged on the support;
charging means, that has a charging member arranged to be in contact with a surface of the electrophotographic photoreceptor, for charging the surface of the electrophotographic photoreceptor by using the charging member;
exposing means for forming an electrostatic latent image on the surface of the electrophotographic photoreceptor charged by the charging means by irradiating the surface of the electrophotographic photoreceptor with exposure light;
developing means for developing the electrostatic latent image on the surface of the electrophotographic photoreceptor formed by the exposing means with toner to form a toner image on the surface of the electrophotographic photoreceptor;
an intermediate transfer body;
a primary transfer member for primarily transferring the toner image on the surface of the electrophotographic photoreceptor formed by the developing means onto a surface of the intermediate transfer body;
a secondary transfer member for secondarily transferring the toner image on the surface of the intermediate transfer body primarily transferred by the primary transfer member onto a transfer material; and
cleaning means, that has a cleaning member arranged to be in contact with the surface of the electrophotographic photoreceptor, for cleaning the surface of the electrophotographic photoreceptor by removing the toner remaining on the surface of the electrophotographic photoreceptor after the primary transfer by the primary transfer member by using the cleaning member, wherein:
the surface of the electrophotographic photoreceptor has a universal hardness value (HU) of 150 N/mm² or more to 220 N/mm² or less, and an elastic deformation rate of 48% or more to 65% or less;
the surface of the intermediate transfer body has a universal hardness value (HU) of 220 N/mm² or less, and an elastic deformation rate of 50% or more; and
the universal hardness value (HU) of the surface of the electrophotographic photoreceptor is greater than the universal hardness value (HU) of the surface of the intermediate transfer body.

2. An electrophotographic apparatus according to claim 1, wherein the surface of the electrophotographic photoreceptor has an elastic deformation rate of 50% or more.

3. An electrophotographic apparatus according to claim 1, wherein the surface of the electrophotographic photoreceptor has a universal hardness value (HU) of 160 N/mm² or more to 200 N/mm² or less.

4. An electrophotographic apparatus according to claims 1, wherein the surface of the intermediate transfer body has a universal hardness value (HU) of 100 N/mm² or less.

5. An electrophotographic apparatus according to claims 1, wherein the surface of the intermediate transfer body has an elastic deformation rate of 80% or less.

6. An electrophotographic apparatus according to claims 1, wherein a surface layer of the electrophotographic photoreceptor comprises a layer formed by polymerizing a hole transporting compound having a chain-polymerizable functional group.

7. An electrophotographic apparatus according to claim 6, wherein the hole transporting compound having a chain-polymerizable functional group comprises a hole transporting compound having two or more chain-polymerizable functional groups.

8. An electrophotographic apparatus according to claim 6, wherein the hole transporting compound having a chain-polymerizable functional group comprises a hole transporting compound having at least one of an acryloyloxy group and a methacryloyloxy group as the chain-polymerizable functional group.

9. An electrophotographic apparatus according to claims 6, wherein the surface layer of the electrophotographic photoreceptor comprises a layer formed by polymerizing the hole transporting compound having a chain-polymerizable functional group by using a radial ray.

10. An electrophotographic apparatus according to claim 9, wherein the radial ray comprises an electron ray.
